(19) United States
(12) Patent Application Publication
(10) Pub. No.: US 2025/0392958 A1
(43) Pub. Date: Dec. 25, 2025

(54) MAC Segmentation

(71) Applicant: Apple Inc., Cupertino, CA (US)

(72) Inventors: Panagiotis BOTSINIS, Munich (DE); Amr Abdelrahman Yousef A MOSTAFA, Neuried (DE); Christian HOFMANN, Munich (DE); Sameh M ELDESSOK, Munich (DE); Tarik TABET, Carlsbad, CA (US)

(21) Appl. No.: 19/247,052

(22) Filed: Jun. 24, 2025

Related U.S. Application Data
(60) Provisional application No. 63/663,268, filed on Jun. 24, 2024.

(51) Int. Cl. H04W 28/06; H04L 1/1812; H04W 72/1273; H04W 72/232

(52) U.S. Cl. CPC H04W 28/065; H04L 1/1812; H04W 72/1273; H04W 72/232

(57) ABSTRACT

An apparatus configured to attempt to decode a first transport block (TB) scheduled for downlink (DL) reception by a first downlink control information (DCI), the first TB associated with a first hybrid automatic repeat request (HARQ) process and containing a first medium access control (MAC) protocol data unit (PDU), when the attempt to decode the first TB and receive the first MAC PDU is unsuccessful, generate, for transmission to a network, a first non-acknowledgment (NACK), detect, in a second DCI, an indication that the first MAC PDU is to be segmented into at least two MAC segments to be transmitted, attempt to decode at least two further TBs, each further TB containing a respective one of the at least two MAC segments and concatenate each successfully decoded MAC segment to receive the first MAC PDU.

### PRIORITY/INCORPORATION BY REFERENCE

This application claims priority to U.S. Application Ser. No. 63/663,268 filed on Jun. 24, 2024, and entitled “MAC Segmentation,” the entirety of which is incorporated by reference herein.

### BACKGROUND

A hybrid automatic repeat request (HARQ) process includes a signaling exchange between a device transmitting data and a device receiving the data, where the receiving device sends feedback to the transmitting device concerning the transmitted data. The feedback may comprise an acknowledgement (ACK) when the transmission is successful (e.g., when the receiver successfully decodes the packet) and a negative acknowledgement (NACK) when the transmission is unsuccessful. The HARQ process includes retransmissions of packets that are unsuccessfully decoded, e.g., with different transmission parameters such as a modulation and coding scheme (MCS) and redundancy bits (redundancy version (RV)). The receiver may buffer the soft bits of the first transmission, and upon receiving the retransmission, may soft combine the new data with the buffered data and attempt to decode the combined data. Subsequent retransmissions may be combined with all previous transmissions.

The HARQ process operates at the physical layer (PHY) and is controlled by the medium access control (MAC) layer. HARQ provides a process for error correction and successful decoding of a transport block (TB) that is faster than, e.g., the automatic repeat request (ARQ) process controlled by the radio link control (RLC) layer in acknowledged mode (AM). However, there are some scenarios where HARQ retransmissions may not improve the decoding probability of the TB, especially if channel conditions were highly degraded during the reception of the initial TB.

### SUMMARY

Some example embodiments are related to an apparatus having processing circuitry coupled to memory, wherein the processing circuitry is configured to attempt to decode a first transport block (TB) scheduled for downlink (DL) reception by a first downlink control information (DCI), the first TB associated with a first hybrid automatic repeat request (HARQ) process and containing a first medium access control (MAC) protocol data unit (PDU), when the attempt to decode the first TB and receive the first MAC PDU is unsuccessful, generate, for transmission to a network, a first non-acknowledgment (NACK), detect, in a second DCI, an indication that the first MAC PDU is to be segmented into at least two MAC segments to be transmitted, attempt to decode at least two further TBs, each further TB containing a respective one of the at least two MAC segments and concatenate each successfully decoded MAC segment to receive the first MAC PDU.

Other example embodiments are related to an apparatus having processing circuitry coupled to memory, wherein the processing circuitry is configured to generate, for transmission to a network, a first transport block (TB) scheduled for uplink (UL) transmission by a first downlink control information (DCI), the first TB associated with a first hybrid automatic repeat request (HARQ) process and containing a first medium access control (MAC) protocol data unit (PDU), detect, in a second DCI, an indication that the first MAC PDU is to be segmented into at least two MAC segments to be transmitted, segment the first MAC PDU into at least two MAC segments and generate, for transmission to the network, at least two further TBs, each further TB containing a respective one of the at least two MAC segments.

Further example embodiments are related to an apparatus having processing circuitry coupled to memory, wherein the processing circuitry is configured to process, based on signaling from a transmitter, a first transport block (TB) associated with a first hybrid automatic repeat request (HARQ) process and containing a first medium access control (MAC) protocol data unit (PDU), wherein at least a portion of the TB is unsuccessfully decoded and process, based on signaling from the transmitter, a second TB comprising a MAC control element (MAC-CE) indicating a level of importance of data in the first TB.

Additional example embodiments are related to an apparatus having processing circuitry coupled to memory, wherein the processing circuitry is configured to generate, for transmission, a first transport block (TB) associated with a first hybrid automatic repeat request (HARQ) process and containing a first medium access control (MAC) protocol data unit (PDU) comprising data, detect, in a second DCI, an indication that the first MAC PDU is to be segmented into at least two MAC segments to be transmitted, segment the first MAC PDU into at least two MAC segments and generate, for transmission to a network, at least two further TBs, each further TB containing a respective one of the at least two MAC segments, wherein a first one of the at least two further TBs comprises a MAC control element (MAC-CE) indicating a level of importance of data in the first TB.

### BRIEF DESCRIPTION OF THE DRAWINGS

FIG. 1 shows a diagram showing a scenario in which a receiver fails to successfully decode a transport block (TB) transmitted with multiple HARQ retransmissions according to one example.

FIG. 2 shows a diagram for MAC segmentation according to various example embodiments.

FIG. 3 shows a diagram for MAC segmentation according to various example embodiments.

FIG. 4 shows a flowchart for HARQ retransmission logic according to one example.

FIG. 5a shows a signaling diagram for DL HARQ retransmissions when MAC segmentation is not enabled and for DL HARQ retransmissions when MAC segmentation is enabled according to various example embodiments.

FIG. 5b shows a signaling diagram for UL HARQ retransmissions when MAC segmentation is not enabled and for UL HARQ retransmissions when MAC segmentation is enabled according to various example embodiments.

FIG. 6 shows a flowchart for HARQ retransmission logic with MAC segmentation according to various example embodiments.

FIG. 7 shows an example network arrangement according to various example embodiments.

FIG. 8 shows an example user equipment (UE) according to various example embodiments.

FIG. 9 shows an example base station according to various example embodiments.

FIG. 10 shows examples of TBs with data having different levels of importance according to various example embodiments.

FIG. 11 shows an example of a TB comprising “important” data and “less important” data according to various example embodiments.

FIG. 12 shows an example signaling diagram showing MAC segmentation transmissions between a transmitter (Tx) and a receiver (Rx) according to various example embodiments.

FIG. 13 shows an example signaling diagram showing MAC segmentation transmissions using code block groups between a transmitter (Tx) and a receiver (Rx) according to various example embodiments.

### DETAILED DESCRIPTION

The example embodiments may be further understood with reference to the following description and the related appended drawings, wherein like elements are provided with the same reference numerals. The example embodiments relate to operations for supporting a segmentation functionality implemented at the medium access control (MAC) layer in coordination with hybrid automatic repeat request (HARQ) processes to improve the reliability and successful decoding of a transport block (TB) in scenarios where HARQ retransmissions may not improve the decoding probability of the TB.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. In particular, the example embodiments may be suitable for implementation in a next generation (e.g., 6G) network. The example embodiments may be utilized with any network implementing HARQ functionalities similar to those described herein, e.g., 5G-Advanced network, 6G network, etc. Therefore, the 5G NR network as described herein may represent any type of network implementing HARQ functionalities similar to the 5G NR network.

The 5G system may implement a protocol stack comprising a number of layers. The packet data convergence protocol (PDCP) layer operates at both the user plane (UP) and the control plane (CP) and performs functions including header compression/decompression of IP data and security operations (e.g., ciphering, deciphering, integrity protection). On the transmitter side, PDCP receives packets (e.g., IP packets) from the higher layers (e.g., radio resource control (RRC) (control plane) or service data adaptation protocol (SDAP) (user plane)), generates PDCP protocol data units (PDU) from PDCP service data units (SDU), and passes the PDCP PDUs to lower layers (e.g., radio link control (RLC)). On the receiver side, PDCP receives RLC PDUs from lower layers (e.g., RLC) and delivers decompressed packets/signaling to the higher layers.

The radio link control (RLC) layer operates at both the UP and the CP and performs functions including segmentation/reassembly, concatenation, and error correction through the automatic repeat request (ARQ) mechanism. On the transmitter side, RLC receives PDCP PDUs, generates RLC PDUs by segmentation/concatenation of RLC SDUs, and passes the RLC PDUs to lower layers (e.g., medium access control (MAC)). On the receiver side, RLC receives RLC PDUs from MAC, reassembles PDCP PDUs from RLC SDUs, and passes them to PDCP. An RLC entity may operate in transparent mode (TM), unacknowledged mode (UM) or acknowledged mode (AM). In TM, RLC directly passes packets without processing (e.g., without adding headers for error correction or sequence delivery). In UM, RLC performs segmentation, reassembly, and in-sequence delivery without retransmissions. In AM, RLC implements ARQ for error correction via retransmission. RLC in UM or AM mode maintains a reassembly timer (t-Reassembly) that is executed at the receiving RLC entity and may range from 0 to hundreds of milliseconds. The expiry of the timer in AM mode may trigger a retransmission and the expiry of the timer in UM mode may trigger packet loss.

The medium access control (MAC) layer operates at both the UP and the CP and performs functions including resource allocation/scheduling, multiplexing/demultiplexing, error correction and retransmissions (through HARQ). On the transmitter side, MAC receives RLC PDUs from multiple logical channels, multiplexes the data into MAC PDUs and maps MAC PDUs onto transport channels for transmission over the physical (PHY) layer. In general, each MAC PDU is mapped to one transport block (TB). The TB may be associated with a HARQ process. On the receiver side, MAC receives MAC PDUs successfully decoded by PHY, demultiplexes MAC SDUs to generate RLC PDUs, and passes the RLC PDUs to RLC.

The transmitting MAC entity comprises a scheduler for dynamically allocating resources for the transmission of TBs. MAC determines the TB size, the modulation and coding scheme (MCS) to be used, and the specific time-frequency resources for the TB transmission. The transmitting MAC entity provides these parameters to PHY, which adds a cyclic redundancy check (CRC), coding and modulation for transmission over the air interface. The receiving MAC entity determines the TB size before attempting to decode the data, using information provided by RRC signaling and downlink control information (DCI). Based on the MCS, the number of transmit layers, and a number of resource elements (determined from a number of resource blocks and a transmission duration), the TB size may be determined. When a receiving PHY entity attempts to decode a TB, if the CRC passes (e.g., any errors in the transmission may be corrected), the receiving PHY entity passes the TB to the MAC layer. When a receiving PHY entity attempts to decode a TB, if the CRC fails (e.g., too many errors are detected such that the TB cannot be decoded), the receiving PHY entity sends a NACK and notifies the MAC layer.

As described above, 5G NR currently supports different retransmission schemes at the PDCP, RLC and MAC layers. HARQ retransmissions at MAC, being performed at the lowest of the three layers, react fastest to channel conditions and improve performance for delay-sensitive applications. RLC retransmissions are limited to logical channels in Acknowledged Mode (AM). The ARQ mechanism corrects errors that pass from HARQ, though on a significantly longer time scale. PDCP retransmissions, being performed at the highest of the three layers, have the highest latency and may be useful during inter-gNB handovers when RLC and MAC are flushed.

The HARQ process operates at the PHY layer and is controlled by the MAC layer. HARQ operation may enhance data transmission reliability by combining forward error correction (FEC) and retransmissions. HARQ includes an acknowledgment/negative-acknowledgement (ACK/NACK) mechanism for indicating whether a transmitted packet was successfully decoded or should be retransmitted. The MAC entity includes a HARQ entity that may maintain a number of parallel HARQ processes. HARQ may be implemented for downlink data transmissions (e.g., a gNB transmitting a physical downlink shared channel (PDSCH) to a UE) or uplink data transmissions (e.g., a UE transmitting a physical uplink shared channel (PUSCH) to a gNB).

When a new transmission takes place, the original data bits are encoded using forward error correction then punctured or rate-matched to create a set of output bits for transmission. Incremental redundancy refers to a retransmission mechanism in which each packet carries different information (systematic bits) and parity bits. The redundancy version (RV) determines which bits are selected for transmission, and different RVs will result in different sets of bits being sent. The initial HARQ transmission is sent with RV0, which typically includes a subset of the encoded data (systematic bits and some parity bits) selected to maximize the likelihood that the receiver may decode the original data correctly. If the initial transmission is not successfully decoded, one or more retransmissions may be sent, e.g., with different RVs and/or different MCS. For each retransmission, the newly received bits may be soft combined with the previously received bits to improve the likelihood of successful decoding.

The base station coordinates retransmissions by scheduling resources and indicating such retransmissions for a given HARQ process in DCI. The DCI scheduling UL or DL transmission (DCI formats 0_0, 0_1, 0_2 for uplink; DCI formats 1_0, 1_1, 1_2 for downlink) may carry HARQ-related fields including a HARQ process field, a new data indicator (NDI) field) and an RV field. If the NDI flag is set to 1 (NDI is toggled), then the transmission scheduled by the DCI is to carry new data and, if the NDI flag is set to 0, then the transmission scheduled by the DCI is to be a HARQ retransmission.

In some cases, HARQ retransmissions may not improve the decoding probability of the TB, especially if the channel conditions were highly degraded during the reception of the initial TB. Any additional HARQ retransmissions may not solve this issue. Additionally, in 5G with incremental redundancy, after four retransmissions (ReTx), the lowest coding rate possible for this transmission has been reached. From the fifth ReTx onwards, only SINR may be increased.

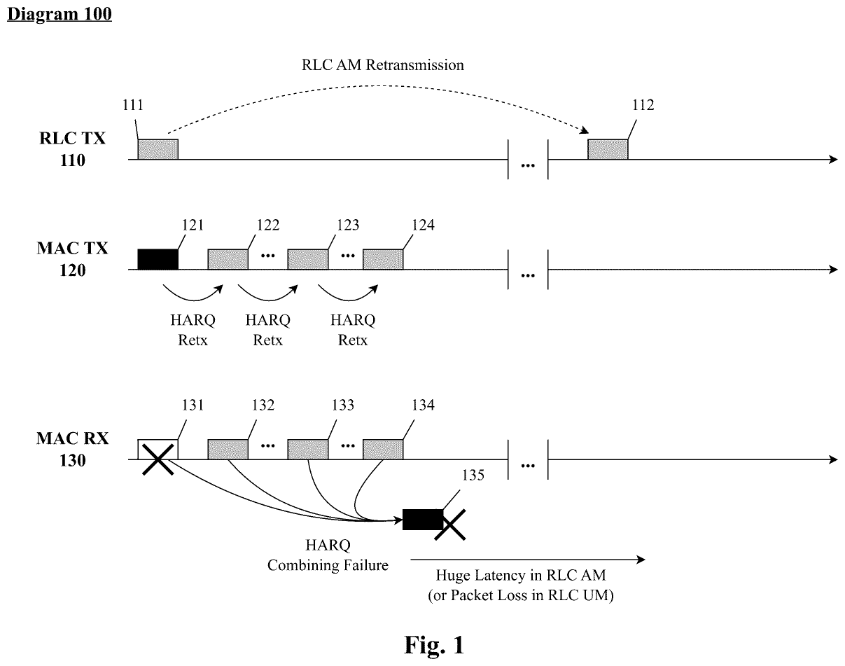

FIG. 1 shows a diagram 100 showing a scenario in which a receiver fails to successfully decode a transport block (TB) transmitted with multiple HARQ retransmissions according to one example. The diagram includes a transmitting RLC entity 110 (RLC TX), a transmitting MAC entity 120 (MAC TX), and a receiving MAC entity 130 (MAC RX). In this example, RLC AM mode is configured with ARQ retransmissions and HARQ retransmissions are configured with a maximum of 3 retransmissions.

In this example, a first TB comprising new data is to be transmitted by the transmitter. The transmitting RLC entity 110 generates a first RLC PDU 111 and passes the packet to the transmitting MAC entity 120. The transmitting MAC entity 120 generates a first MAC PDU 121, maps the first MAC PDU 121 to a transport block (TB), and passes the TB to a transmitting PHY entity (not shown) with parameters for transmitting the TB. The PHY layer takes the TB, adds a CRC and applies a MCS to transmit the TB over the air interface.

The receiver attempts to decode the first TB. A receiving PHY entity (not shown) detects the radio signal, demodulates the received signal, attempts to decode the TB and performs the CRC to detect errors. In this example, the decoding is unsuccessful. The receiving PHY entity transmits a NACK to the transmitter. The receiving MAC entity 130 is informed of the unsuccessful decoding (131) and the soft bits of the received TB are buffered.

The transmitting MAC entity 120 attempts a first HARQ retransmission 122 of the first MAC PDU 121. If incremental redundancy is used, the first HARQ retransmission 122 comprises a different RV. The transmitting PHY maps the first HARQ retransmission 122 to a second TB, applies a different MCS, etc. The decoding of the second TB by the receiving PHY entity is unsuccessful, a NACK is sent, and the soft bits are buffered. Two more HARQ retransmissions (123, 124) are transmitted and unsuccessfully decoded at the PHY layer. The receiving MAC entity 130 is informed of the unsuccessful decoding of each of the three retransmissions (132-134) and the HARQ combining failure 135. When the RLC AM retransmission timer expires, the transmitting RLC entity 110 attempts a first ARQ retransmission 112.

Accordingly, in current HARQ processes, the following issues are identified: unnecessary HARQ retransmissions (wasting resources and therefore increasing latency of other transmissions); packet loss in case of RLC UM due to failing HARQ combining, as RLC UM purely relies only on MAC for ensuring error-free reception of the RLC PDUs; Packet latencies and jitter in case of RLC AM due to failing HARQ combining. RLC Status reporting and RLC ARQ retransmissions ensure the lossless transmission but the latency and jitter per packet increases.

To address the foregoing issues, the example embodiments describe a new segmentation functionality implemented at the MAC layer in coordination with HARQ retransmission processes to improve the reliability and successful decoding of a transport block (TB) in scenarios where HARQ retransmissions may not improve the decoding probability of the TB. The MAC layer may include a new function that may be referred to herein as “MAC segmentation for HARQ retransmissions” that is applicable in both DL and UL and is independent of the content of the MAC PDU (e.g., the MAC PDU includes full or partial RLC PDUs). In some embodiments, a transmitting MAC entity may segment a MAC PDU into multiple MAC segments for successive (e.g., sequential) transmission. Each MAC segment comprises fewer bits than the original MAC PDU. The same time-frequency resources may be used in combination with a lower MCS to transmit the fewer information bits of each MAC segment. This would result in a more reliable transmission. Each MAC segment may be mapped to a respective TB and, when TBs carrying each MAC segment are successfully decoded, the MAC segments may be concatenated and passed to RLC.

In the specific cases where HARQ retransmissions would have not helped the decoder, MAC may determine such conditions and reset the transmission of the TB. In some embodiments, the MAC entity at the base station may determine based on some internal logic that MAC segmentation should be applied. The logic may comprise, e.g., a maximum number of HARQ retransmissions of the initial TB has been reached and that radio conditions are such that MAC segmentation would be beneficial, as determined based on, e.g., CSI information. In some embodiments, the MAC entity at the UE may determine based on some internal logic that MAC segmentation should be applied. In this case, the UE may optionally request the base station to apply MAC segmentation.

Each MAC segment may be associated with the original HARQ process and, if a given MAC segment is not decoded properly on a first attempt, HARQ retransmissions may be used. The MAC segments are transmitted sequentially, including any retransmissions. In other words, a second MAC segment is not transmitted until a first MAC segment is properly decoded. The signaling details for this functionality are described in greater detail below.

A greater number of slots may be used to transmit all MAC segments when MAC segmentation is applied. The RLC reassembly timer (“RLC t-Reassembly”) should cover HARQ ReTXs of the original (non-segmented) MAC PDU. As an optional feature, if timer extension is used, a dynamic RLC reassembly timer (“Dynamic RLC t-Reassembly”) may be used to cover the HARQ ReTXs of all segments of the segmented MAC PDU.

The decision to do MAC segmentation should not take place before, at least, the initial transmission of the original MAC PDU has been NACKed. It stops the ongoing HARQ retransmissions of the affected TB and, at that point, the HARQ buffers of the HARQ process associated with the affected TB may be reset. As described above, in some embodiments, the decision to stop the HARQ retransmissions of the original TB and perform MAC segmentation may be made when a pre-determined number of failed HARQ retransmissions has been reached and the available CSI information indicates that this scheme would be beneficial. In some embodiments, the soft bits of the original TB carrying the full MAC PDU (which was unsuccessfully decoded) may be buffered and combined with the MAC segments to facilitate proper decoding.

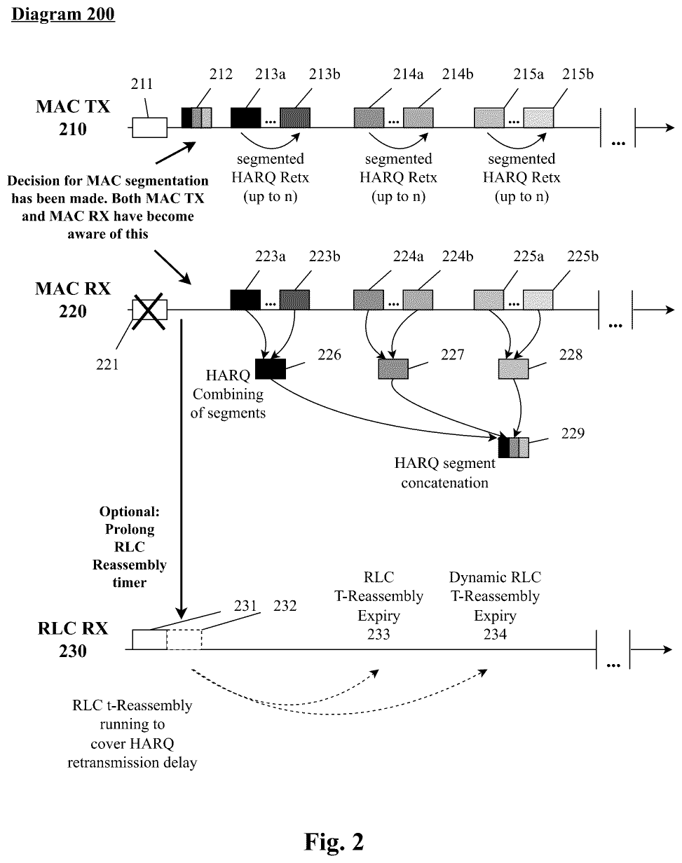

FIG. 2 shows a diagram 200 for MAC segmentation according to various example embodiments. The diagram 200 includes a transmitting MAC entity 210 (MAC TX), a receiving MAC entity 220 (MAC RX), and a receiving RLC entity 230 (RLC RX).

In this example, the transmitting MAC entity 210 generates a first MAC PDU 211, maps the first MAC PDU 211 to a first TB, and passes the first TB to a transmitting PHY entity. The PHY layer adds a CRC, applies an MCS, etc. A receiving PHY entity (not shown) detects the radio signal, demodulates the received signal, attempts to decode the TB and performs the CRC to detect errors. In this example, the decoding is unsuccessful. The receiving PHY entity transmits a NACK to the transmitter. The receiving MAC entity 220 is informed of the unsuccessful decoding (221) and the soft bits of the received TB are buffered. The receiving RLC entity 230 is informed of the unsuccessful decoding (231) and the RLC reassembly timer 233 is started.

According to the present embodiments, the decision is made to perform MAC segmentation. To be described in greater detail below, the MAC entity at the base station may determine that MAC segmentation should be applied and may signal this to the UE in DCI scheduling the first MAC segment. Thus, the transmitting MAC entity 210 and the receiving MAC entity 220 are aware that MAC segmentation has been triggered. The receiving RLC entity 230 may be informed of this (232) and, in some embodiments, a dynamic RLC reassembly timer 234 is started.

The transmitting MAC entity 210 generates a segmented MAC PDU 212. In this example, three MAC segments are generated. The transmitting MAC entity 210 generates a first MAC segment 213a, a second MAC segment 214a, and a third MAC segment 215a. The newly generated MAC segments are transmitted sequentially with the original HARQ process. This means that only the first MAC segment will be transmitted after MAC segmentation and only after that first MAC segment has been correctly decoded will the second MAC segment be transmitted. The same process continues until all MAC segments have been received. This way, there is no need to add sequence numbers or segment IDs in MAC. The receiver will sequentially assemble the received MAC segments of the same HARQ process. This is different from RLC concatenation because 5G does not have the functionality of sequential retransmission of RLC segments.

The receiving MAC entity 220 attempts to decode the TBs carrying the MAC segments. For the first segment 213a, the receiving MAC entity 220 attempts to decode a received TB carrying the first MAC segment 223a and retransmission(s) 223b by soft combining. When the receiving MAC entity 220 successfully decodes the first segment (226), an ACK is sent and the transmitting MAC entity 210 transmits the second segment 214a. The receiving MAC entity 220 attempts to decode a received TB carrying the second MAC segment 224a and retransmissions(s) 224b by soft combining. When the receiving MAC entity 220 successfully decodes the second segment (227), an ACK is sent and the transmitting MAC entity 210 transmits the third segment 215a. The receiving MAC entity 220 attempts to decode a received TB carrying the third MAC segment 225a and retransmissions(s) 225b by soft combining. When the receiving MAC entity 220 successfully decodes the third segment (228), an ACK is sent. The receiving MAC entity 220 then concatenates the MAC segments (229).

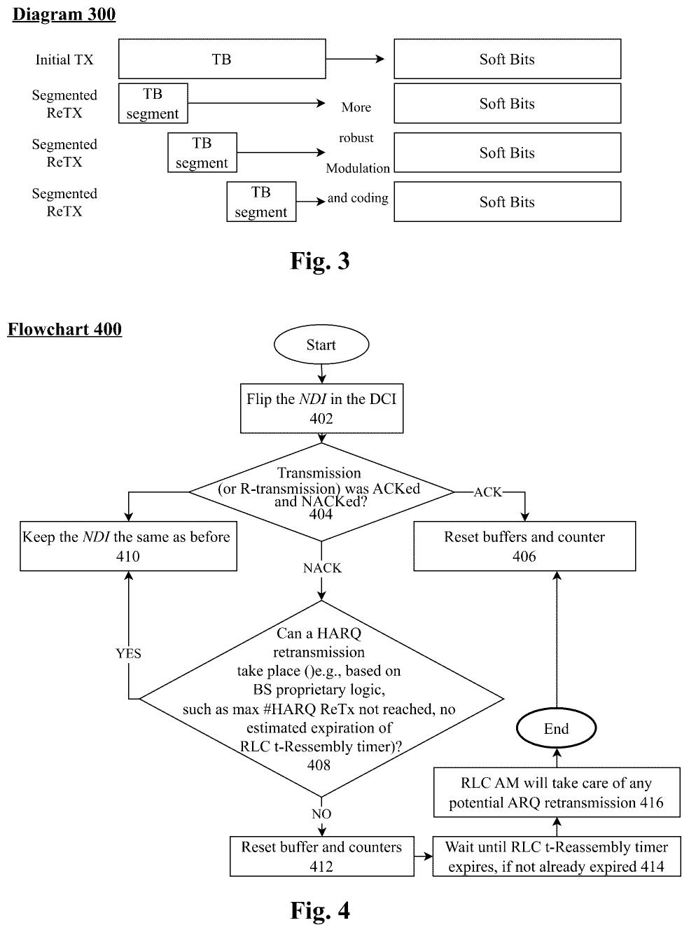

FIG. 3 shows a diagram 300 for MAC segmentation according to various example embodiments. An initial TB 301 is transmitted by the transmitter and, when the receiver unsuccessfully decodes the initial TB 301, soft bits 305 corresponding to the systematic bits of the initial TB 301 are buffered. A first MAC segment 302, a second MAC segment 303, and a third MAC segment 304 are transmitted by the transmitter with a more robust MCS and the soft bits 306, 307, 308 corresponding to the systematic bits of these TBs are buffered for eventual combining by the receiver.

The receiver does not have to wait until it receives all MAC segments in order to process their content. For example, MAC CEs may be immediately applied once decoded. The number of MAC segments is not pre-determined but rather depends on the employed MCS and time-frequency resources used for the next-in-line MAC segment (e.g., the TB size of each MAC segment).

In current 5G specifications, it is up to network implementation to continue or stop HARQ retransmissions. The base station may include proprietary logic that dictates whether a HARQ retransmission should be sent, including, e.g., a maximum number of HARQ retransmissions. This logic is on top of the RLC logic including the associated RLC reassembly timer (t-reassembly). In other words, HARQ retransmissions may be stopped by the base station even though RLC t-Reassembly is still running.

In current 5G specifications, the UE follows the content in the DCI scheduling the DL/UL transmission to receive new data (DL), to perform HARQ combining (DL), to send new data (UL), or to perform a retransmission (UL). DCI formats 0_0, 0_1, 0_2 may schedule a UL transmission of data (PUSCH) and formats 1_0, 1_1, 1_2 may schedule a DL transmission of data (PDSCH). These DCI formats may carry HARQ-related information in fields including a new data indicator (NDI) field (1 bit), a redundancy version (RV) field (0-2 bits), and a HARQ process number field (0-4 bits). If the DCI is scheduling a retransmission, the NDI field does not change. If the DCI is scheduling new data, the NDI field toggles.

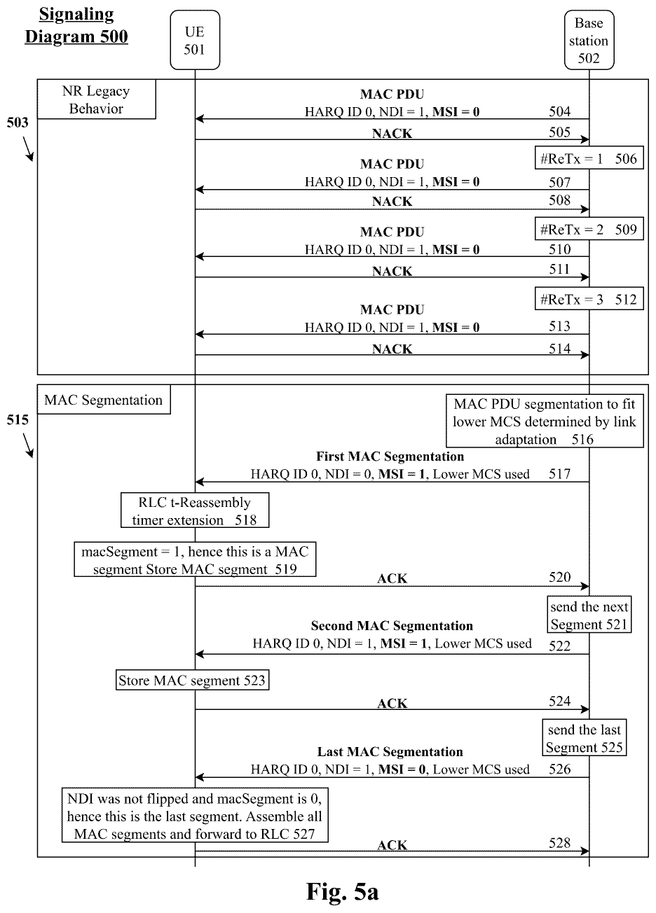

FIG. 4 shows a flowchart 400 for HARQ retransmission logic according to one example. The flowchart 400 is generally described from the perspective of a base station, however, the principles are also applicable to the UE as described below. The example flowchart 400 is applicable to both DL and UL HARQ processes.

In one example scenario, a DL DCI format may carry an NDI toggled to indicate new DL data (e.g., flipped to 1 from 0 or to 0 from 1). The base station transmits and the UE attempts to decode a PDSCH scheduled by the DCI. If the UE successfully decodes the TB at the physical layer, the UE sends an ACK. The PHY layer passes the decoded TB to MAC and MAC processes the successfully decoded MAC PDU (e.g., demultiplexes). MAC passes RLC PDUs to the RLC layer for further processing (concatenation, etc.) and ends the current HARQ process. If the base station detects the ACK, the base station resets its buffers and counters to end the current HARQ process. This scenario is represented by steps 402-406 of the flowchart 400 (402 “Flip the NDI in the DCI”, 404 “Transmission (or Re-transmission) was ACKed or NACKed?”, if ACK, 406 “Reset buffers and counters”).

In another example scenario, for a first DL DCI format indicating new DL data (NDI toggled), if the UE is unsuccessful in decoding the TB, the UE sends a NACK. When the base station detects the NACK, the base station may schedule a HARQ retransmission. The base station may keep the NDI at the same value (e.g., does not toggle the NDI) and transmit a second DL DCI format for the same HARQ process. This scenario is represented by steps 402-404, 408-410 of the flowchart 400 (402 “Flip the NDI in the DCI”, 404 “Transmission (or Re-transmission) was ACKed or NACKed?”, if NACK, 408 “May a HARQ retransmission take place?”, if yes, 410 “Keep the NDI the same as before”).

If the first HARQ retransmission is successfully decoded, the UE PHY sends an ACK and the UE MAC passes the successfully decoded MAC PDU to the RLC layer. The base station detects the ACK and resets its buffers and counters to end the current HARQ process. This scenario is represented by steps 404-406 of the flowchart 400, as described above. If the UE is unsuccessful in decoding the first HARQ retransmission, the UE sends another NACK. The base station continues to send retransmissions as long as the base station logic allows for retransmissions. This scenario is represented by repeating steps 404, 408-410 of the flowchart 400, as described above.

If the UE is unsuccessful in decoding the TB and the retransmission logic dictates that no more HARQ retransmissions should occur, the HARQ process ends and the RLC layer will address any potential ARQ retransmissions. In one example, the maximum number of HARQ retransmissions was reached. In another example, the RLC reassembly timer was estimated to expire. This scenario is represented by steps 408, 412-416 of the flowchart 400 (408 “May a HARQ retransmission take place (e.g., based on BS proprietary logic, such as max #HARQ ReTx not reached, no estimated expiration of RLC t-Reassembly timer)?”, if no, 412 “Reset buffers and counters”, 414 “Wait until RLC t-Reassembly timer expires, if not already expired”, 416 “RLC AM will take care of any potential ARQ retransmissions”).

In another example scenario, a UL DCI format may carry an NDI toggled to indicate new DL data (e.g., flipped to 1 from 0 or to 0 from 1). The UE transmits and the base station attempts to decode a PUSCH scheduled by the DCI. If the base station successfully decodes the TB at the physical layer, the ACK is not explicitly transmitted but may be assumed by the UE based on the lack of any further UL DCIs scheduling this HARQ process (with NDI remaining the same) prior to the expiration of RLC t-Reassembly. The base station MAC passes the successfully decoded MAC PDU to the RLC layer for further processing (concatenation, etc.) resets its buffers and counters and ends the current HARQ process. This scenario is represented by steps 402-406 of the flowchart 400, as described above.

In another example scenario, for a first UL DCI format indicating new UL data (NDI toggled), if the base station is unsuccessful in decoding the TB, the base station may schedule a HARQ retransmission. The base station may keep the NDI at the same value (e.g., does not toggle the NDI) and transmit a second UL DCI format for the same HARQ process. This scenario is represented by steps 402-404, 408-410 of the flowchart 400, as described above.

If the first HARQ retransmission is successfully decoded, the base station MAC passes the successfully decoded MAC PDU to the RLC layer for further processing (concatenation, etc.), resets its buffers and counters and ends the current HARQ process. This scenario is represented by steps 404-406 of the flowchart 400, as described above. If the base station is unsuccessful in decoding the first HARQ retransmission, the base station may continue to send DCIs scheduling UL retransmissions if the base station logic allows for further retransmissions. This scenario is represented by repeating steps 404, 408-410 of the flowchart 400, as described above.

If the base station is unsuccessful in decoding the TB and the retransmission logic dictates that no more HARQ retransmissions should occur, the HARQ process ends and the RLC layer will address any potential ARQ retransmissions. In one example, the maximum number of HARQ retransmissions was reached. In another example, the RLC reassembly timer was estimated to expire. This scenario is represented by steps 408, 412-416 of the flowchart 400, as described above.

The MAC retransmission logic as described above remains valid in view of the example embodiments described herein for MAC segmentation.

In some aspects of these example embodiments, a single bit flag MacSegmentationIndication (MSI) may be added in the DCI. A value of MSI=0 may indicate that the TB associated with the HARQ process is a full MAC PDU or a last MAC segment of a MAC PDU and a value of MSI=1 may indicate that the TB associated with the HARQ process is a non-last MAC segment of a MAC PDU.

As described above, MAC segmentation should not be applied until the transmission of at least one initial MAC PDU containing new data is attempted. The base station may determine to apply MAC segmentation based on proprietary logic, e.g., when a predetermined maximum of HARQ retransmissions is reached (1 or greater) or at any time after the initial transmission fails if the base station determines that the reliability of the transmission may be increased, e.g., in view of CSI information.

In some aspects of these example embodiments, when the base station makes the decision to segment the MAC PDU and starts the transmission of the MAC segments, the New Data Indication (NDI) at the DCI of the initial transmission of a MAC segment is set to indicate new transmission. The same takes place between transmission of different MAC segments, so that the receiver does not combine bits of different MAC segments. When the last MAC segment is transmitted, this should be indicated by not flipping the NDI and by setting MSI=0.

In some aspects of these example embodiments, each MAC segment may be re-transmitted itself with different redundancy versions, enabling per MAC segment combining. In theory, the specific information bits of the original TB that are included in the nth MAC segment could be HARQ-combined with the information bits of the nth MAC segment. This would be implementation specific.

The original TB size may be readjusted (e.g., by removing the padding that was potentially included in the original TB). In the DL, the base station is aware of the padding of the original TB, therefore it may readily take this information into consideration when determining which MAC segment is the last one. In the UL, TB size adjustment is possible in the scenarios where the MAC subheader that indicates padding has been received in a MAC segment that is not the last segment, essentially making that the last MAC segment. This logic may be applied at the gNB, which will not provide any more grants for MAC segments to the UE.

The MAC RX entity may indicate additional HARQ delay due to the ongoing MAC segmentation process ongoing towards the higher layers, e.g., to RLC RX entity to prolong the t-Reassembly timer and allow successful reassembly, or to PDCP RX entity to prolong reordering. The prolongation values could be defined in the spec.

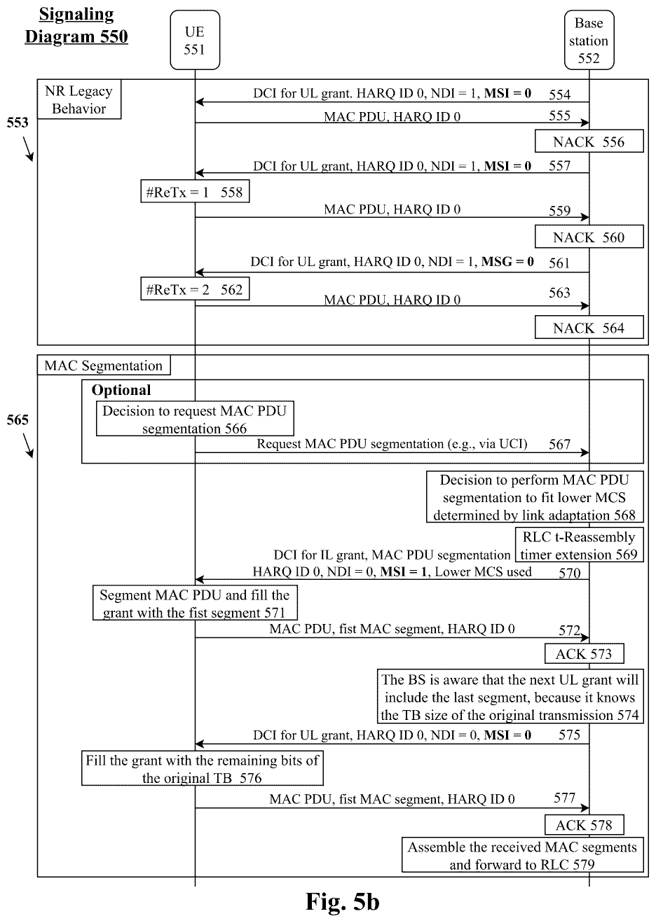

FIG. 5a shows a signaling diagram 500 for DL HARQ retransmissions when MAC segmentation is not enabled and for DL HARQ retransmissions when MAC segmentation is enabled according to various example embodiments; FIG. 5b shows a signaling diagram 550 for UL HARQ retransmissions when MAC segmentation is not enabled and for UL HARQ retransmissions when MAC segmentation is enabled according to various example embodiments;

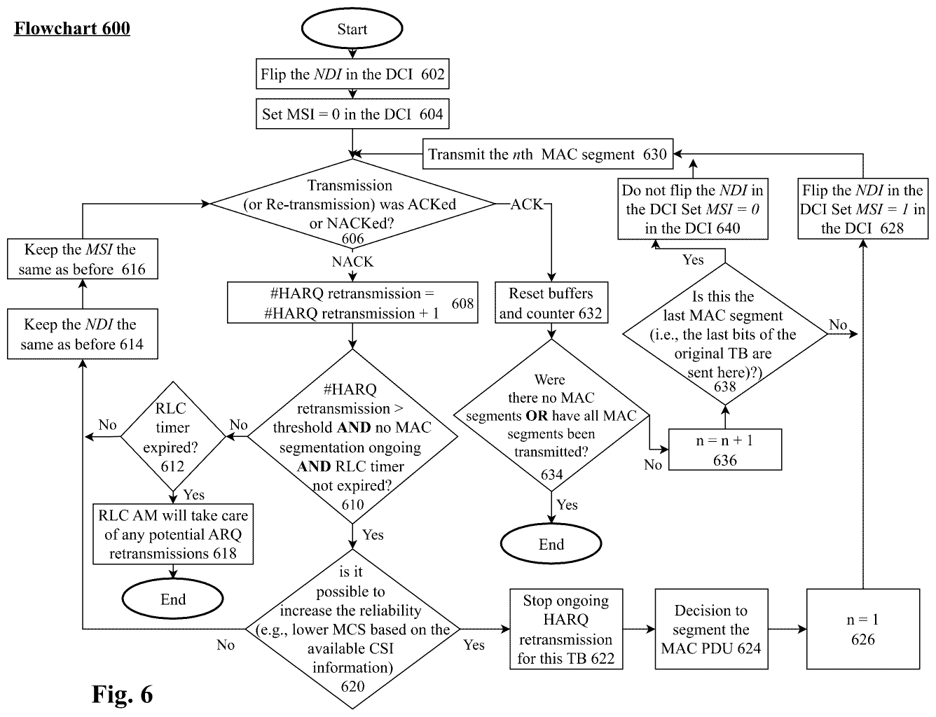

FIG. 6 shows a flowchart 600 for HARQ retransmission logic with MAC segmentation according to various example embodiments. The flowchart 600 is generally described from the perspective of a base station, however, the principles are also applicable to the UE as described below. The example flowchart 600 is applicable to both DL and UL HARQ processes with MAC segmentation.

With regard to the DL example of FIG. 5a, the signaling diagram 500 includes a UE 501 and a base station 502. A first part 503 of the signaling diagram 500 corresponds to legacy behavior according to one example and a second part 515 of the signaling diagram 500 corresponds to MAC segmentation according to one example.

In the first part 503 of the signaling diagram 500, MAC segmentation is not enabled. The base station 502 transmits a first MAC PDU 504 scheduled by a DL DCI indicating a first HARQ ID value and with NDI toggled (e.g., from 0 to 1). The MAC segmentation indicator (MSI) indicates 0 (no MAC segmentation). The UE 501 attempts to decode the first MAC PDU 504 and is unsuccessful. The UE 501 buffers the soft bits of the first MAC PDU 504 and sends a first NACK 505. The base station 502 detecting the first NACK 505 increments its retransmission counter to 1 (506). The base station 502 transmits a second MAC PDU 507 (first HARQ retransmission) scheduled by a DL DCI indicating the first HARQ ID, with NDI not toggled (e.g., kept as 1) and MSI unchanged (indicating 0—no MAC segmentation). The UE 501 combines the soft bits of the second MAC PDU 507 with those of the first MAC PDU 504, attempts to decode the combined bits, and is unsuccessful. The UE 501 buffers the soft bits of the second MAC PDU 507 and sends a second NACK 508. The base station 502 detecting the second NACK 508 increments its retransmission counter to 2 (509). A third MAC PDU 510 (second HARQ retransmission) is transmitted, unsuccessfully decoded by soft combining the third MAC PDU 510 with the prior two transmissions, buffered, and NACKed (511). The retransmission counter is incremented to 3 (512). A fourth MAC PDU 513 (third HARQ retransmission) is transmitted, unsuccessfully decoded by soft combining the fourth MAC PDU 513 with the prior three transmissions, and NACKed (514). Prior to each of the four transmissions, the RLC reassembly timer had not yet expired. This scenario is represented by steps 602-616, repeating steps 606-616 for the first two retransmissions, and repeating step 606 for the third retransmission of the flowchart 600 (602 “Flip the NDI in the DCI”, 604 “Set MSI=0 in DCI”, 606 “Transmission (or Re-transmission) was ACKed or NACKed?”, if NACK, 608 “#HARQ retransmissions=#HARQ retransmissions+1” (increment retransmission counter), 610 “#HARQ retransmissions >threshold AND no MAC Segmentation ongoing AND RLC timer not expired”, if no, 612 “RLC timer expired?”, if no, 614 “Keep the NDI the same as before”, 616 “Keep the MSI the same as before”, return to 606). For the condition of 610, the number of HARQ retransmissions is not greater than the threshold for the three retransmissions.

The proprietary logic of the base station may have a maximum of three retransmissions (or the RLC t-Reassembly has expired prior to the maximum ReTx being reached). In either case, when the RLC t-Reassembly expires, RLC AM will take care of any potential ARQ retransmissions or RLC UM will determine a packet loss. This scenario is represented by steps 608-612, 618 of the flowchart 600 (608 “#HARQ retransmissions=#HARQ retransmissions+1” (increment retransmission counter), 610 “#HARQ retransmissions >threshold AND no MAC Segmentation ongoing AND RLC timer not expired”, if no, 612 “RLC timer expired?”, if yes, 618 “RLC AM will take care of any potential ARQ retransmissions”). For the condition of 610, the RLC timer has expired (the condition is not satisfied).

In the second part 515 of the signaling diagram 500, MAC segmentation is enabled. The base station 502 determines to apply MAC PDU segmentation so that the MAC segments may fit to a lower MCS determined by link adaptation (516). The base station 502 transmits a first MAC PDU 517 corresponding to a first MAC segment scheduled by a DL DCI indicating a first HARQ ID value (the HARQ ID being the same as the HARQ ID used in the initial (non-segmented) transmission), with NDI toggled and the MAC segmentation indicator (MSI) indicates 1 (a non-last MAC segment is scheduled). The first MAC segment is transmitted with a lower MCS than the initial (non-segmented) transmission. The UE 501 attempts to decode the first MAC PDU 517. In this example, the UE 501 applies the dynamic RLC reassembly timer 518 to extend the timer duration (this is an optional feature). The UE 501 is successful in decoding the first MAC PDU 517 corresponding to the first MAC segment. In some example embodiments, the UE 501 may decode the first MAC segment by soft-combining the first MAC PDU 517 with an initial (unsegmented) transmission. The UE 501 is aware from the MSI value that the first MAC PDU 517 is a MAC segment and accordingly stores the first MAC segment (519). This scenario is represented by steps 610, 620-630 of the flowchart 600 (610 “#HARQ retransmissions >threshold AND no MAC Segmentation ongoing AND RLC timer not expired”, if yes, 620 “Is it possible to increase the reliability (e.g., lower MCS based on the available CSI information)?”, if yes, 622 “Stop ongoing HARQ retransmissions for this TB”, 624 “Decision to segment the MAC PDU”, 626 “n=1”, 628 “Flip the NDI in the DCI, Set MSI=1 in the DCI”, 630 “Transmit the nth MAC segment” (first MAC segment)). For the condition of 610, the HARQ retransmission threshold is exceeded, no MAC segmentation is ongoing, and the RLC timer has not expired (the condition is satisfied). Further, for the condition of 620, the base station uses proprietary logic to infer that MAC segmentation would be beneficial. In other scenarios, the condition of 610 may be satisfied but the base station determines, based on, e.g., channel conditions, that MAC segmentation would not be beneficial. In this case, the condition of 620 is not satisfied and the process flow returns to 614. It is noted that, in this example, the HARQ ReTx threshold considered in 610 corresponds only to the decision of whether to enable MAC segmentation in 620. However, it should be understood that two different HARQ ReTx thresholds may be used wherein a first threshold corresponds to the MAC segmentation decision and a second threshold corresponds to stopping HARQ retransmissions (despite unsuccessful decoding TB) and allowing an RLC timer to expire, e.g., for the original TB (when MAC segmentation is not used) and/or for each of the respective MAC segments. In this example, the ReTX threshold for stopping HARQ retransmissions is assumed to be infinity. In some embodiments, the first ReTx threshold ‘a’ for enabling MAC segmentation can be lower than the second ReTX threshold ‘b’ for stopping HARQ retransmissions, while in other embodiments, the first and second ReTx thresholds can be equal, e.g., b≥a.

If the first MAC segment is not successfully decoded by the UE, the first MAC segment may be retransmitted according to HARQ processes. The UE may send a NACK and, when the base station detects the NACK, the base station may retransmit the first MAC segment with NDI and MSI unchanged. This scenario is represented by repeating steps 606-616, as described above for each retransmission of the MAC segment. If the first MAC segment (or any MAC segment) is not successfully decoded before the max number of HARQ retransmissions is reached for that segment, or before the RLC timer expires, then the HARQ process ends and the RLC AM will handle ARQ retransmissions. This scenario is represented by steps 606-612, 618, as described above.

Returning to the signaling diagram 500 of FIG. 5a, after successfully decoding the first MAC PDU 517 (first MAC segment), the UE sends a first ACK 520. The base station 502 detecting the first ACK 520 determines to transmit the second MAC segment (521). The base station 502 transmits a second MAC PDU 522 corresponding to a second MAC segment scheduled by a DL DCI indicating the first HARQ ID value and with NDI toggled (e.g., from 0 to 1) to indicate a new transmission (so that the UE does not combine bits of different MAC segments). The MAC segmentation indicator (MSI) indicates 1 (a non-last MAC segment is scheduled). The second MAC segment is transmitted with a lower MCS than the initial (non-segmented) transmission. The UE 501 attempts to decode the second MAC PDU 522. The UE 501 is successful in decoding the second MAC PDU 522 corresponding to the second MAC segment. The UE 501 is aware from the MSI value that the second MAC PDU 522 is a non-last MAC segment and accordingly stores the second MAC segment (523). This scenario is represented by steps 606, 632-638, 628-630 (606 “Transmission (or Re-transmission) was ACKed or NACKed?”, if ACK, 632 “Reset buffers and counters”, 634 “Were there no MAC segments OR have all MAC segments been transmitted?”, if no, 636 “n=n+1”, 638 “Is this the last MAC segment (i.e., the last bits of the original TB are sent here?”, if no, 628 “Flip the NDI in the DCI, Set MSI=1 in the DCI”, 630 “Transmit the nth MAC segment” (second MAC segment)).

Returning to the signaling diagram 500 of FIG. 5a, after successfully decoding the second MAC PDU 522 (second MAC segment), the UE 501 sends a second ACK 524. The base station 502 detecting the second ACK 524 determines to transmit the third MAC segment (525). In this example, the third MAC segment is the last MAC segment. The base station 502 transmits a third MAC PDU 526 corresponding to a third MAC segment scheduled by a DL DCI indicating the first HARQ ID value, with NDI not toggled (e.g., remains at 1) and the MAC segmentation indicator (MSI) indicates 0 (indicating, in combination, that a last MAC segment is scheduled). The third MAC segment is transmitted with a lower MCS than the initial (non-segmented) transmission. The UE 501 attempts to decode the third MAC PDU 526. The UE 501 is successful in decoding the third MAC PDU 526 corresponding to the third MAC segment. The UE 501 is aware from the NDI/MSI values that the third MAC PDU 526 is a last MAC segment and accordingly assembles the first, second and third MAC segments (527). The UE 501 send an ACK 528 indicating the successful decoding of the third MAC segment and the subsequent concatenation of the three segments. This scenario is represented by steps 606, 632-640, 630, 606, 632-634 (606 “Transmission (or Re-transmission) was ACKed or NACKed?”, if ACK, 632 “Reset buffers and counters”, 634 “Were there no MAC segments OR have all MAC segments been transmitted?”, if no, 636 “n=n+1”, 638 “Is this the last MAC segment (i.e., the last bits of the original TB are sent here?”, if no, 628 “Flip the NDI in the DCI, Set MSI=1 in the DCI”, 630 “Transmit the nth MAC segment” (third MAC segment), 606 “Transmission (or Re-transmission) was ACKed or NACKed?”, if ACK, 632 “Reset buffers and counters”, 634 “Were there no MAC segments OR have all MAC segments been transmitted?”, if yes (all MAC segments have been transmitted), End).

The MAC segmentation mechanism may be triggered either while the t-Reassembly timer is inactive at the RX or shortly after the t-Reassembly timer is initiated. The motivation is that enough time should be allowed in order for the MAC RX to receive the multiple MAC segments and forward them to RLC RX. As a design option, the configured t-Reassembly timer may be very low, matching a small, expected number of HARQ retransmissions. When MAC segmentation is triggered, then MAC RX may indicate to RLC RX that t-Reassembly timer should be prolonged by a pre-determined value.

With regard to the UL example of FIG. 5b, the signaling diagram 550 includes a UE 551 and a base station 552. A first part 553 of the signaling diagram 550 corresponds to legacy behavior according to one example and a second part 565 of the signaling diagram 550 corresponds to MAC segmentation according to one example.

In the first part 553 of the signaling diagram 550, MAC segmentation is not enabled. The base station 552 transmits a first UL DCI 554 indicating a first HARQ ID value and with NDI toggled (e.g., from 0 to 1). The MAC segmentation indicator (MSI) indicates 0 (no MAC segmentation). The UE 551 transmits a first MAC PDU 555 scheduled by the UL DCI 554. The base station 552 attempts to decode the first MAC PDU 555 and is unsuccessful (NACK 556). The base station 552 buffers the soft bits of the first MAC PDU 508. No NACK is explicitly signaled, and the base station 552 implicitly signals the NACK by proceeding to schedule HARQ retransmissions. The base station 552 transmits a second UL DCI 557 indicating the first HARQ ID value, with NDI unchanged (e.g., remains at 1) and MSI unchanged (indicating 0—no MAC segmentation). The UE 551 increments the retransmission counter to 1 (558) and transmits a second MAC PDU 559 (first HARQ retransmission). The base station 552 combines the soft bits of the second MAC PDU 559 with those of the first MAC PDU 555, attempts to decode the combined bits, and is unsuccessful (NACK 560). The base station 552 buffers the soft bits of the second MAC PDU 559. The base station 552 transmits a third UL DCI 561 indicating the first HARQ ID value, with NDI unchanged (e.g., remains at 1) and MSI unchanged (indicating 0—no MAC segmentation). The UE 551 increments the retransmission counter to 2 (562) and transmits a third MAC PDU 563 (second HARQ retransmission). The base station 552 combines the soft bits of the third MAC PDU 563 with the prior two transmissions, attempts to decode the combined bits, and is unsuccessful (NACK 564). Prior to each of the two retransmissions, the RLC reassembly timer had not yet expired. This scenario is represented by steps 602-616, repeating steps 606-616 for the first retransmission, and repeating step 606 for the second retransmission of the flowchart 600, as described above with regard to the first part 503 of the DL signaling diagram 500 of FIG. 5a.

Returning to the signaling diagram 550 of FIG. 5b, in this example, the proprietary logic of the base station has a maximum of two retransmissions or the RLC t-Reassembly has expired prior to the maximum ReTx being reached. In either case, when the RLC t-Reassembly expires, RLC AM will take care of any potential ARQ retransmissions or RLC UM will determine a packet loss. This scenario is represented by steps 608-612, 618 of the flowchart 600, as described above with regard to the first part 503 of the DL signaling diagram 500 of FIG. 5a.

In the second part 565 of the signaling diagram 550, MAC segmentation is enabled. Optionally, the UE 551 may determine to request MAC PDU segmentation (566). The UE 551 may transmit a request 567 via, e.g., uplink control information (UCI). The base station 552 can, in response to the request or for another reason according to its proprietary logic, determine to apply MAC PDU segmentation so that the MAC segments may fit to a lower MCS determined by link adaptation (568). In this example, the base station 552 applies the dynamic RLC reassembly timer 569 to extend the timer duration (this is an optional feature). The base station 552 transmits a first UL DCI 570 indicating a first HARQ ID value (the HARQ ID being the same as the HARQ ID used in the initial (non-segmented) transmission), with NDI toggled and the MAC segmentation indicator (MSI) indicates 1 (which, in combination, indicate that a first MAC segment is scheduled). The UE 551 segments the MAC PDU (571). The number of MAC segments is not predetermined but rather depends on the employed MCS and time-frequency resources used for the next-in-line MAC segment (i.e., the TB size of each MAC segment). The UE 551 transmits a first MAC PDU 572 corresponding to a first MAC segment scheduled by the UL DCI 570. The first MAC segment is transmitted with a lower MCS than the initial (non-segmented) transmission. The base station 552 attempts to decode the first MAC PDU 572 and is successful (ACK 573). The base station 552 stores the first MAC segment. This scenario is represented by steps 610, 620-630 of the flowchart 600, as described above with regard to the second part 515 of the DL signaling diagram 500 of FIG. 5a.

If the first MAC segment is not successfully decoded by the base station, the first MAC segment may be retransmitted according to HARQ processes. The base station may schedule the UE with an UL grant by DCI indicating an NDI that is not toggled and a MSI equal to 1. This scenario is represented by steps 606-616, as described above, for each HARQ retransmission. If the first MAC segment (or any MAC segment) is not successfully decoded before the max number of HARQ retransmissions is reached for that segment, or before the RLC timer expires, then the HARQ process ends and the RLC AM will handle ARQ retransmissions. This scenario is represented by steps 606-612, 618, as described above.

Returning to the signaling diagram 550 of FIG. 5b, after successfully decoding the first MAC PDU 572 (first MAC segment), no ACK is explicitly signaled by the base station 552. The base station 552 implicitly signals the ACK 573 by proceeding to schedule transmissions of further MAC segments.

If the next MAC segment is not the last segment, the base station 552 may transmit a DCI indicating the first HARQ ID value, with NDI toggled to indicate a new transmission (so that the UE does not combine bits of different MAC segments) and MSI indicating 1 (a non-last MAC segment is scheduled). This scenario is represented by steps 606, 632-638, 628-630, as described above.

In this example, based on the TB size of the original transmission, the base station 552 determines that the next UL grant will include the last segment (574). The base station 552 transmits a second UL DCI 575 indicating the first HARQ ID value, with NDI unchanged (e.g., remains at 0) and MSI set to 0 (which, in combination, indicate that a last MAC segment is scheduled). The UE 551 fills the UL grant with the remaining bits of the original TB (576). The UE 551 transmits a second MAC PDU 577 corresponding to a second and last MAC segment. The second MAC segment is transmitted with a lower MCS than the initial (non-segmented) transmission. The base station 552 attempts to decode the second MAC PDU 577 and is successful (ACK 578). The base station 552 concatenates the MAC segments and forwards the TB to RLC (579). This scenario is represented by steps 606, 632-634 of the flowchart 600 (606 “Transmission (or Re-transmission) was ACKed or NACKed?”, if ACK, 632 “Reset buffers and counters”, 634 “Were there no MAC segments OR have all MAC segments been transmitted?”, if yes (all MAC segments have been transmitted), End).

In the UL, the BS should become aware of when the last MAC segment is scheduled, so that it sets the NDI and macSegment bits in the DCI accordingly. The BS is aware of that because it may keep track of the sum of information bits of each segment and compare it to the TB size of the original TB. If the sum of the segment sizes is greater than or equal to the original TB size, then the latest segment is the last MAC segment.

In UL, it may also be up to the base station to decide if the UE should proceed with HARQ retransmissions or if the UE should perform MAC segmentation. In that case, the decisions may be based on the same information as for DL, with the difference that no HARQ feedback is used since the base station is already aware of whether it has received the MAC PDU or not.

In addition to the above, the UE may have its own logic of when to perform MAC segmentation. In that case, the UE may inform the base station that it would like to perform MAC segmentation on a specific HARQ process. This could be done via a new MAC CE added in another MAC PDU or via UCI. If the base station receives that MAC CE or UCI, it may consider the UE request and ask the UE to perform MAC segmentation on that HARQ process. In both cases, the BS may indicate to the UE that it should perform MAC segmentation to the contents of a specific HARQ process. This may be done in the DCI via the proposed MacSegmentationIndication bit.

Accordingly, the above described MAC segmentation scheme enables multiple benefits. For RLC UM bearers, MAC segmentation provides increased reliability due to lower packet loss on HARQ level (segmenting of a once transmitted RLC PDU upon HARQ failures). For RLC AM bearers, MAC segmentation provides reduced latency due to lower packet loss on HARQ level. Additionally, the need for RLC AM status reports and slower RLC retransmissions may be reduced. Additionally, MAC segmentation provides a simple mechanism that may reduce the need for RLC AM. For example, lower complexity devices with only RLC UM are possible.

Additionally, MAC segmentation provides HARQ performance improvements including better BW utilization, since a HARQ process that is not promising may be reset and utilized for a more robust, sequential MAC segment transmission. HARQ latency may be reduced, by starting over with more robust modulation and coding scheme that may be completed faster.

In the above described example embodiments, various examples of decoding MAC segments were described. The following describes some additional example operations that may be used in conjunction with the above example embodiments to further improve decoding of MAC segments. These additional example operations may also be used separately without some or all of the example operations described above.

As described above, each MAC segment may be re-transmitted itself with different redundancy versions, enabling per MAC segment combining. The specific information bits of the original TB that are included in the nth MAC segment may be HARQ-combined with the information bits of the nth MAC segment. For example, systematic channel codes are currently used in 5G networks and are also expected to be used in 6G networks. Systematic channel codes mean that the information bits (e.g., the bits of the TB before it was encoded) are transmitted over the air, along with the parity bits. The receiver has already stored the soft bits (e.g., the content of the HARQ buffer) of the original TB, because the receiver is attempting to decode the TB. Each soft bit has a sign (+/−), corresponding to the bit value (e.g., +x means that the bit is most likely a 0, −x means that the bit is most likely a 1). The value x of the soft bit indicates the level of confidence that the bit is a 0 or a 1 (e.g., +infinity (inf) means that the bit is definitely a 0, while +0.01 means that there is a higher chance the bit is equal to 0 than 1, but the decoder is not very confident about it.

This stored information may be used to increase the accuracy and speed of decoding. For example, when a MAC segment is successfully decoded, the information bits of that segment are known at the receiver. The receiver may set the soft bits of those specific bits in the original TB HARQ buffer to the maximum values with the +/− sign that corresponds to the decoded bit value (e.g., +inf if the bit is 0, −inf if the bit is 1). The receiver may then attempt to decode the original TB again by using the updated HARQ buffer. The channel decoding performance of the original TB may be improved because a part of the original TB is now known.

Enabling this type of HARQ combining is new and unique to MAC segmentation, because the HARQ buffer of the original TB may still be available at the receiver. In the uplink (UL), no additional signaling may be used to implement this type of HARQ combining. In the downlink (DL), the UE may indicate in the HARQ feedback whether the original TB has been correctly decoded, if only the transmitted MAC segment was correctly decoded or if the transmitted MAC segment was not correctly decoded. The UE may indicate in the HARQ feedback of the original TB which MAC segments may be helpful for decoding the original TB (e.g., the MAC segments that contain not yet correctly decoded code blocks).

In the above example embodiments, it was described that the MAC segments may be transmitted sequentially, e.g., when the first MAC segment has been correctly received, then the second MAC segment may be transmitted. This may be continued until all MAC segments have been received. However, the example embodiments are not limited to sequential transmission of the MAC segments.

In some example embodiments, the MAC segments that correspond to a same TB may be transmitted in parallel. In these example embodiments, when any MAC segment is successfully decoded, the process of setting the soft bits of the original TB to a definite value (e.g., +/− infinity) as described above may be performed and the attempt to decode the original TB may be performed based on the soft bits for the original TB stored in the HARQ. This may improve the channel decoding performance and reduce latency even when the first (or earlier) MAC segments cannot be successfully decoded.

These example embodiments related to parallel transmission of the MAC segments may use modified signaling from the sequential transmission of MAC segments described above. In one option, a MAC segment ID may be added to each DCI requesting a MAC segment. Each MAC segment may be transmitted with the same HARQ process as the original TB or a different HARQ process per MAC segment provided there is an indicated mapping between the original and the new HARQ process. When a DCI is sent requesting a MAC segment ID, the network may indicate which MAC segment ID is to be transmitted in the associated PDSCH/PUSCH occasion.

Regardless of whether the UE is the transmitter or receiver, in some example embodiments, the UE may determine the mapping between the MAC segment ID X and the original TB by having received DCIs for all MAC segment IDs from 0 up to X-1 and computing the size of those MAC segments (e.g., summing up to the original TB size). In other example embodiments, a bit offset of the MAC segment with respect to the original TB may be added in the DCI, so that the UE may use this information to create MAC segment ID X without having created MAC segment IDs 0 . . . . X-1. Explicit HARQ feedback for a MAC segment (e.g., in the DL) may indicate the associated HARQ process, as well as the MAC segment.

In another option, a MAC segmentation header may be added in each MAC segment to indicate the MAC segment ID and the MAC segments bit offset with respect to the original TB. Upon successfully decoding of a MAC segment, the receiver may then determine the part of the original TB that is in the MAC segment. In this option, the transmitter may not have to wait for an explicit or implicit ACK/NACK of the MAC segment ID before transmitting another MAC segment ID.

In some example embodiments, in the UL, the UE may indicate to the network if a TB contains data of different importance, [symbol] e.g. different radio bearers (acknowledged mode (AM)/unacknowledged mode (UM)) and different MAC CEs. This information may be conveyed to the network by adding a new MAC-CE at the beginning of a TB that is to be segmented. This new MAC-CE may indicate a level of importance of the TB content. For example, the levels of importance may be “important,” “less important” or “partially important.” These levels are only examples and any number of importance levels may be defined and the level of importance (e.g., numerical level, priority level, etc.) may be defined in any manner.

In this example, the “important” indication may mean that the TB includes important data where segmentation is performed for the entire TB. The “less important” indication may mean that the TB includes less important data and segmentation may stop after the first segment. The “partially important” indication may mean that the TB includes both important data and less important data and the segmentation may stop after the important data. Some examples of the segmentation of these different levels of data are described below.

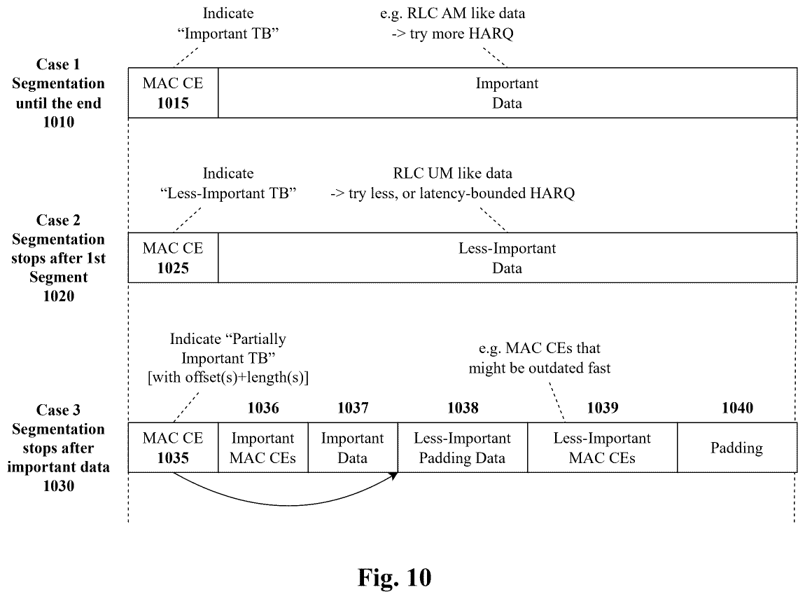

FIG. 10 shows examples of TBs with data having different levels of importance according to various example embodiments. As described above, when segmentation is applied in the UL, the UE may include the new MAC-CE at the beginning of the TB to indicate the level of importance of the data in the TB. This indication may be, for example, a flag, a bit field, etc. This information may be used by the network to run different HARQ strategies for the TB.

FIG. 10 shows the TB 1000 that is to be transmitted in the UL by the UE. Initially, a first case 1010 (Case 1) of the TB 1000 including “important” data is described. As stated above, a MAC-CE 1015 indicating the importance level of the data in the TB is added to the TB 1000. In this example, the data is indicated as “important,” e.g., RLC AM data. In this case, the segmentation may be performed for the entire TB as described in detail above. Thus, when the network decodes the first segment including the MAC-CE 1015, the network may determine that the TB 1000 includes important data and the network may attempt to decode all segments of the TB 1000.

In a second case 1020 (Case 2), the TB 1000 may include “less important” data. A MAC-CE 1025 indicating the importance level of the data in the TB is added to the TB 1000. In this example, the data is indicated as “less important,” e.g., RLC UM data. In this case, when the network decodes the first segment including the MAC-CE 1025, the network may determine that the TB 1000 includes less important data and may abort further decoding of segments of the TB 1000. For example, the network may stop decoding the segments of the TB 1000 and indicate NDI toggling to the UE to start with new data.

In a third case 1030 (Case 3), the TB 1000 may include “partially important” data, e.g., both important and less important data. A MAC-CE 1035 indicating the importance level of the data in the TB is added to the TB 1000. As shown in FIG. 10, the TB 1000 includes important data 1036 and 1037 (e.g., important MAC CEs, RLC AM like data that requires nearly lossless transmission, etc.) that may be subject to sophisticated HARQ retransmissions and less important data 1038 and 1039 (e.g., MAC CEs that may be outdated quickly or RLC UM like data) and padding 1040. As shown in FIG. 10, the MAC-CE 1035 may also include the length (e.g., x bytes) and/or offset of associated with the important data 1036 and 1037.

In some example embodiments, the network (e.g., a base station), based on received buffer status information (e.g., a Buffer Status Report (BSR) received from the UE) may determine a segment size for the first TB segment size to cover different portions of the TB 1000, e.g., only the new MAC CE 1035, the new MAC CE 1035 and a certain amount of important MAC CEs, a predicted portion of important data to conclude after the reception of the first segment, etc.

When the network decodes the MAC-CE 1035 and determines the TB 1000 includes both important information and less important information, the network may perform various operations. For example, the network may decode the segments of the TB 1000 until all the important data 1036 and 1037 are decoded. As described above, the MAC-CE 1035 may include an indication of the length or the offset of the important data 1036 and 1037 and thus, the network may determine when the segments having the important data 1036 and 1037 are decoded. As also described above, in some example embodiments, the first segment may be sized such that all the important data 1036 and 1037 is included in the first segment. Thus, in these example embodiments, after decoding the first segment, the network may have the important data 1036 and 1037. In cases where the important data 1036 and 1037 extends beyond the first segment, the network may adjust the remaining segment size(s) to match the remaining important data part. This may allow the UE to encode those remaining segments having important data with an even more robust MCS.

After the important data 1036 and 1037 is received, the network may abort the segmentation process similar to the operations described above for Case 2 1020, e.g., stop decoding the segments of the TB 1000 and indicate NDI toggling to the UE to start with new data.

In the above example embodiments, the “important” data and the “less important” data in the “partially important” TBs were ordered. However, in some example embodiments described in greater detail below, the “important” data and the “less important” data may not be ordered. These example embodiments may be applied to both the UL and the DL as will be described in greater detail below.

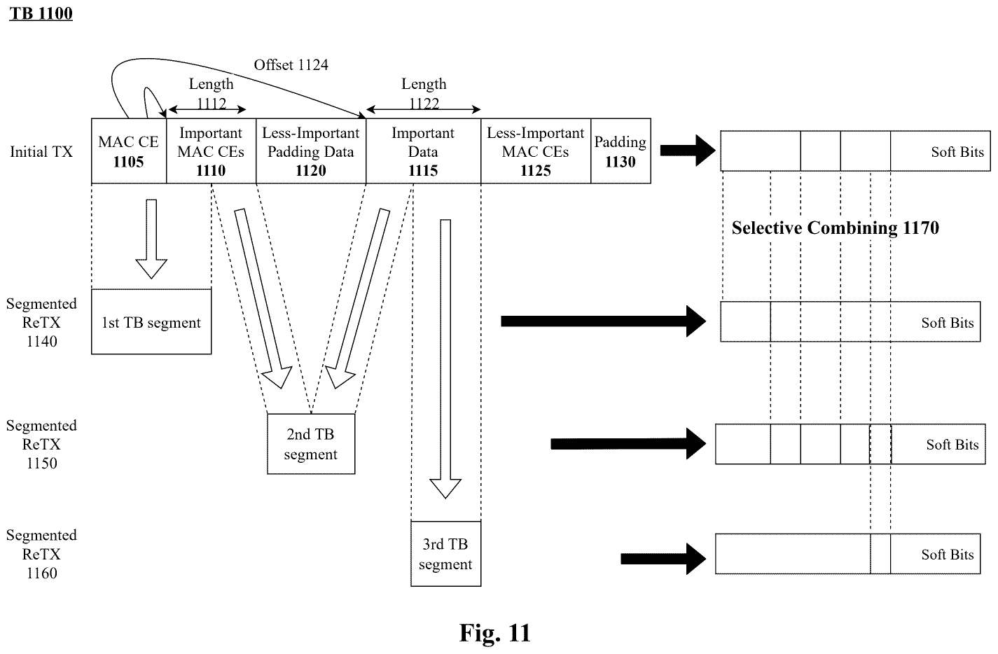

FIG. 11 shows an example of a TB 1100 comprising “important” data and “less important” data according to various example embodiments. In the example of FIG. 11, the TB 1100 comprises the new MAC-CE 1105 indicating that the TB 1100 includes both “important” data and “less important” data. As shown in FIG. 11, this “important” data and “less important” data is not ordered in the TB 1100, e.g., important data 1110 is followed by less important data 1115, which is followed by important data 1120, which is followed by less important data 1125, which is followed by padding 1130.

The MAC-CE 1105, in addition to the indication of “partially important” may also include an indication of the length 1112 and 1122 of the important data 1110 and 1115, respectively. Since the important data 1110 immediately follows the MAC-1105 there may not be an offset related to the important data 1110. However, there may be an offset 1124 related to the important data 1115, e.g., an offset value from the start/end of the MAC-CE 1105.

In this example, the transmitter (e.g., UE in the UL or base station in the DL), may segment the TB 1100 into multiple segments based on configured segment sizes. In this example, the transmitter may segment the TB into three segments 1140-1160. The first segment 1140 may include the MAC-CE 1105 and a portion of the important data 1110. The second segment 1150 may include the remaining portion of the important data 1110 and a portion of the important data 1120. The third segment 1160 may include the remaining portion of the important data 1120. The segmentation and the size of the segmentation in FIG. 11 is only an example and other segmentation (e.g., 2 segments, 4 segments, etc.) may be used with different segments sizes. The point of the example of FIG. 11 is to illustrate that the transmitter may segment the TB 1100 such that the segments only include important information. Thus, the receiver may treat the segments similar to the Case 1 1010 from FIG. 10 (e.g., decode all the segments) because each of the segments include important information.

In these example embodiments, in the UL, once the network has successfully decoded the first TB segment (e.g., the segment with the new MAC-CE), the network may determine the amount of important data and how the important data is distributed in the TB. Thus, the network may request segment sizes that accommodate the amount of important bytes remaining in the TB. The UE, upon receiving the grant may generate the segments including only the important bytes in the same order as the TB segments. The network, using the offsets and lengths of the important bytes, may then perform selective combining 1170 as shown in FIG. 11 with the corresponding soft bits from the initial TB to decode the segments.

In the DL, the network is aware of the TB content and in control of the HARQ process and therefore may determine whether to perform segmentation and which bytes are important to be retransmitted in the next segments. However, to enable the UE to do selective combining 1170, the network may add the new MAC-CE 1105 in the DL transmissions to inform the UE of the various information concerning the segments.

In the above example embodiments, the new MAC-CE, e.g., MAC-CEs 1015, 1025, 1035 of FIG. 10 and MAC-CE 1105 of FIG. 11, were added to the original TB and the first segment. However, in some example embodiments, the new MAC-CE may be added to only the first segment (e.g., not the original TB). This may reduce overhead associated with the original TB. In addition, if the new MAC CE is a fixed-size, the receiver may be aware of the size and may perform HARQ combining of the remaining data bits with the original TB prior to decoding the first MAC segment.

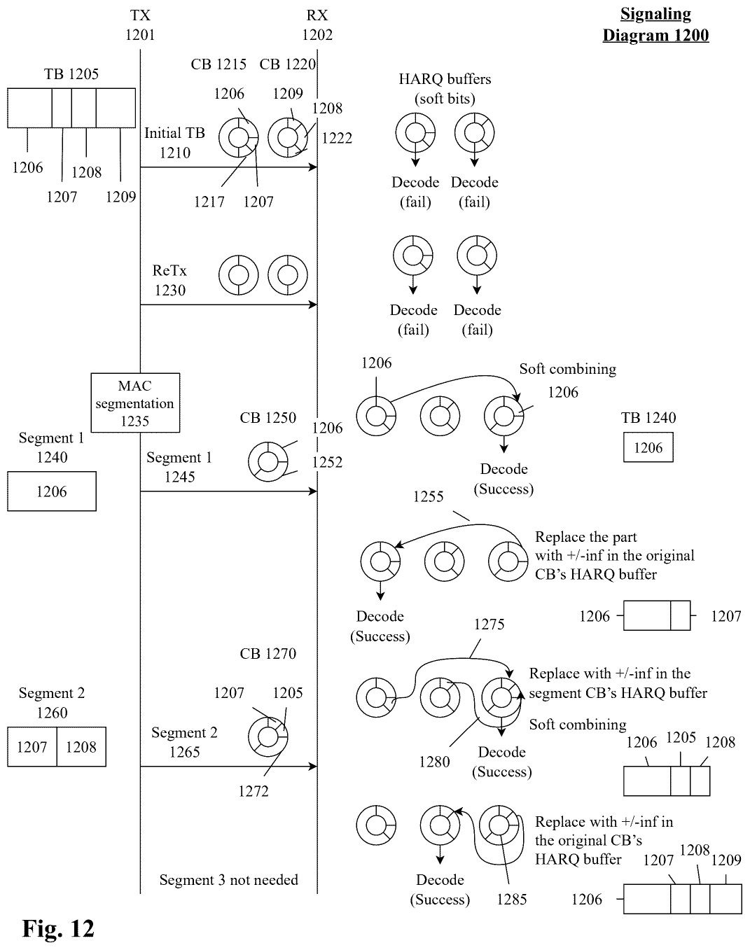

FIG. 12 shows an example signaling diagram 1200 showing MAC segmentation transmissions between a transmitter (Tx) 1201 and a receiver (Rx) 1202 according to various example embodiments. The signaling diagram 1200 may show a transmission in the UL (e.g., UE is Tx 1201 and base station is Rx 1202) or the DL (e.g., base station is Tx 1201 and UE is Rx 1202).

Initially, the TB 1205 to be transmitted is shown. In this example, the TB 1205 comprises data 1206-1209. In 1210, the Tx 1201 transmits the TB 1205. In this example, the TB 1205 is divided into two codeblocks (CBs) 1215 and 1220. The CB 1215 comprises the data 1206 and 1207 and parity bits 1217. The CB 1220 comprises the data 1208 and 1209 and parity bits 1222. The Rx 1202 attempts to decode the CBs 1215 and 1220 and stores the soft bits of the CBs 1215 and 1220 in the HARQ buffer. In this example, it may be considered that the decoding has failed as shown in FIG. 12. While not shown in FIG. 12, the Rx 1202 may send a NACK back to the Tx 1201 indicating the CBs have not been successfully decoded.

In 1230, the Tx 1201 may retransmit the CBs 1215 and 1220 in a similar manner as 1210. Again, Rx 1202 may attempt to decode the CBs 1215 and 1220 and the soft bits may be stored in the HARQ buffer. Again, in this example, it may be considered that the decoding of the retransmission is also unsuccessful and the Rx 1202 may send a NACK to the Tx 1201 (not shown).

In 1235, the Tx 1201 may determine to use MAC segmentation to transmit the TB 1205. Each MAC segment may channel encoded as a separate TB. The size of a MAC segment may not be determined a priori, but may depend on the current channel state and may be computed at the Rx 1202 based on the information in the DCI. New MCS tables may be specified for the MAC segments.

Thus, the Tx 1201 may segment the original TB 1205 into multiple segments. A first segment 1240 may include the data 1206 of the original TB 1205. In 1245, the Tx 1201 may transmit a CB 1250 having the data 1206 and parity bits 1252. Upon receipt of the CB 1250, the Rx 1202 may soft combine the bits of the data part 1206 of the CB 1250 and the bits of the data part 1206 of the CB 1215 (e.g., stored in the HARQ buffer) to attempt to decode the data part 1206. This soft combining of the data bits of a MAC segment with the corresponding data bits of the original TB may be applied prior to attempting to decode the MAC segment (e.g., CB 1250). In this example, the decoding of the data part 1206 may be successful. After the MAC segment 1240 has been successfully decoded, the original HARQ buffer associated with the original TB may be updated by setting the soft bits (e.g., Log-Likelihood Ratios (LLRs)) to the hard-coded values (e.g., +/− inf LLRs as described above). This is shown as operation 1255 in FIG. 12. The Rx 1202 may then attempt to decode the corresponding CB(s) again, e.g., in this example CB 1215. As shown in FIG. 12, this may result in successful decoding of the CB 1215 that includes the data part 1206 and 1207.

The parts of a MAC segment (e.g., MAC segment 1 1240) that were correctly decoded as part of the CB 1215 of the original TB 1205 may be set as hard-coded bits (e.g., +/− inf LLRs) in the HARQ buffer of the MAC segment 1240, prior to decoding the MAC segment 1240.

Continuing with the example of FIG. 12, the Tx 1201 may generate a second segment 1260 having the data parts 1207 and 1208, which are transmitted in 1265 in CB 1270 having data parts 1207 and 1208 and parity bits 1272. As described above, the data part 1207 may have already been successfully decoded in the original CB 1215. Thus, in 1275 the soft bits of the second segment 1260 may be replaced with the known values (e.g., +/− inf LLRs) in the CB 1270. In 1280, the soft bits of the data part 1208 of the segment 1260 may be combined with the soft bits of the data part 1208 of the original CB 1220. In this example, the decoding of the MAC segment 120 may be successful resulting, at this point, in the successful decoding of the data parts 1206-1208.

In 1285, the soft bits of the successfully decoded data part 1208 may be replaced with the known values (e.g., +/− inf LLRs) in the original CB 1220. Then, the Rx 1202 may attempt to decode the original CB 1220. In this example, this decoding is successful resulting, at this point, in the successful decoding of the data parts 1206-1209. Thus, because all the data parts 1206-1209 are successfully decoded, there is no need for additional segments.

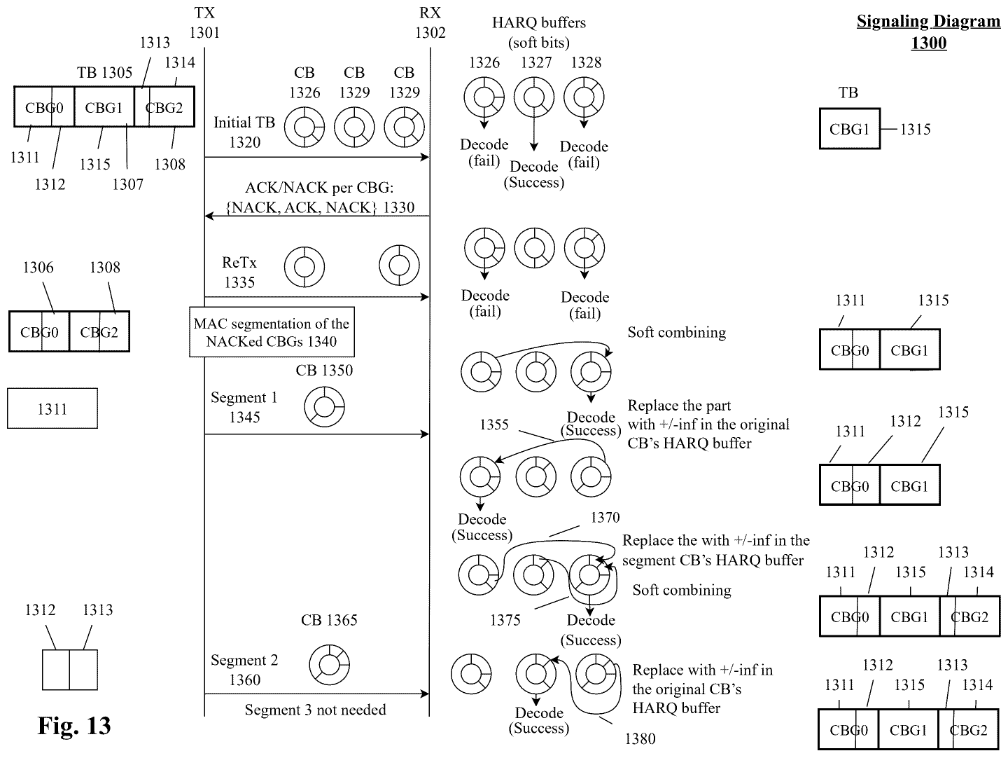

FIG. 13 shows an example signaling diagram 1300 showing MAC segmentation transmissions using code block groups between a transmitter (Tx) 1301 and a receiver (Rx) 1302 according to various example embodiments. The signaling diagram 1300 may show a transmission in the UL (e.g., UE is Tx 1301 and base station is Rx 1302) or the DL (e.g., base station is Tx 1301 and UE is Rx 1302).

In this example, the original TB 1305 comprises three (3) codeblock groups (CBGs) 1306-1308. The CBG 1306 comprises two data parts 1311 and 1312, the CBG 1307 comprises a single data part 1315 and the CBG 1308 comprises two data parts 1313 and 1314. In 1320, the Tx 1301 sends CBs 1326, 1327 and 1328 corresponding to the CBGs 1306, 1307 and 1308, respectively. In this example, it may be considered that the CBs 1326 and 1328 are not successfully decoded but the CB 1327 is successfully decoded.

When CBGs are used, the Rx 1302 may send 1-bit HARQ feedback to the Tx 1301 per CBG, instead of 1-bit HARQ feedback for the whole TB 1305. This means that the Tx 1301 is aware of which CBGs have been correctly decoded and which CBGs have not been correctly decoded. Thus, in 1330, the Rx 1302 may send a HARQ ACK for the CB 1327 (corresponding to the CBG 1307) and NACKs for the CBs 1326 and 1328 (corresponding to the CBGs 1306 and 1308, respectively).

In 1335, the Tx 1301 may then retransmit the CBs 1326 and 1328 that were not successfully decoded. In this example, the CBs 1326 and 1328 are again not successfully decoded. The Rx 1302 may again send NACKs for the retransmission of the CBs 1326 and 1328 (not shown).

MAC segmentation may also be used in combination with the CBG feature. As shown in 1340, the Tx 1301 may only segment and transmit the data of the CBGs that were not correctly decoded, e.g., CBGs 1306 and 1308. A first MAC segment may include the data part 1311 of the first CBG 1306 that was not correctly decoded. Thus, in 1345, the Tx 1301 may transit a CB 1350 having the data part 1311 to the Rx 1302. The Rx 1302 may soft combine the soft bits of the data part 1311 of the original CBG 1306 with the soft bits of the data part 1311 of the CB 1350. In this example, the decoding of the data part 1311 may be successful. Thus, at this point, the data part 1311 of the CBG 1306 and the data part 1315 of the CBG 1307 have been successfully decoded.

In 1355, the soft bits of the data part 1311 of the original CB 1326 are replaced with the known values (e.g., +/− inf LLRs) and the Rx 1302 may attempt to decode the CB 1326. In this example, the decode is successful and at this point, the data part 1311 and 1312 of the CBG 1306 and the data part 1315 of the CBG 1307 have been successfully decoded.

The Tx 1301 may then generate a second segment comprising the data part 1312 and 1313 which may then be transmitted in 1360 in a CB 1365. When generating segments, the Tx 1301 may use the data from the CBGs that were not correctly decoded in order until the TB size of the MAC segment has been reached. This same process may then continue for the following MAC segments, continuing from where the previous MAC segment stopped.

To continue with the example of FIG. 13, in 1370, the Rx 1302 may replace the soft bits of the data part 1312 with the known values (e.g., +/− inf LLRs) in the CB 1365. In 1375, the soft bits of the data part 1313 of the segment 1260 may be combined with the soft bits of the data part 1313 of the original CB 1328. In this example, the decoding of the MAC segment may be successful resulting, at this point, in the successful decoding of the data parts 1311, 1312, 1313 and 1315.

In 1380, the soft bits of the successfully decoded data part 1313 may be replaced with the known values (e.g., +/− inf LLRs) in the original CB 1328. Then, the Rx 1302 may attempt to decode the original CB 1328. In this example, this decoding is successful resulting, at this point, in the successful decoding of the data parts 1311-1315. Thus, because all the data parts 1311-1315 are successfully decoded, there is no need for additional segments.

In these example embodiments related to the CBGs, the amount of data that may be segmented and transmitted may be reduced compared to the non-CBG case, since data that has already been successfully decoded at the Rx may not be re-transmitted.

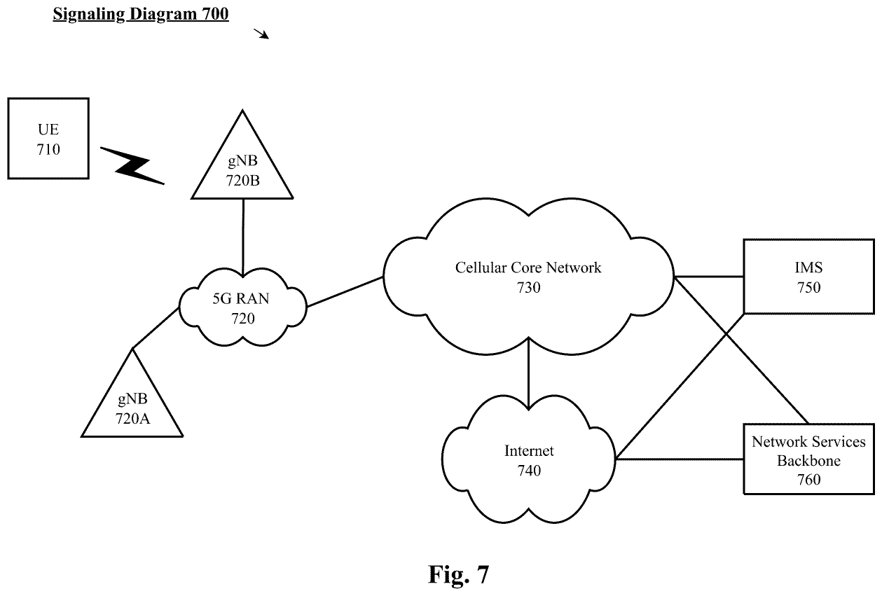

FIG. 7 shows an example network arrangement 700 according to various example embodiments. The example network arrangement 700 includes a UE 710. The UE 710 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 710 is merely provided for illustrative purposes.

The UE 710 may be configured to communicate with one or more networks. In the example of the network arrangement 700, the network with which the UE 710 may wirelessly communicate is a 5G NR radio access network (RAN) 720. However, the UE 710 may also communicate with other types of networks (e.g., 5G cloud RAN, a next generation RAN (NG-RAN), a legacy cellular network, etc.) and the UE 710 may also communicate with networks over a wired connection. With regard to the example embodiments, the UE 710 may establish a connection with the 5G NR RAN 720. Therefore, the UE 710 may have a 5G NR chipset to communicate with the NR RAN 720.

The 5G NR RAN 720 may be portions of a cellular network that may be deployed by a network carrier (e.g., Verizon, AT&T, T-Mobile, etc.). The RAN 720 may include cells or base stations that are configured to send and receive traffic from UEs that are equipped with the appropriate cellular chip set. In this example, the 5G NR RAN 720 includes the gNB 720A and the gNB 720B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 710 to connect to the 5G NR RAN 720. For example, as discussed above, the 5G NR RAN 720 may be associated with a particular network carrier where the UE 710 and/or the user thereof has a contract and credential information (e.g., stored on a SIM card). Upon detecting the presence of the 5G NR RAN 720, the UE 710 may transmit the corresponding credential information to associate with the 5G NR RAN 720. More specifically, the UE 710 may associate with a specific cell (e.g., gNB 720A).

The network arrangement 700 also includes a cellular core network 730, the Internet 740, an IP Multimedia Subsystem (IMS) 750, and a network services backbone 760. The cellular core network 730 manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UE 710 in communication with the various networks.

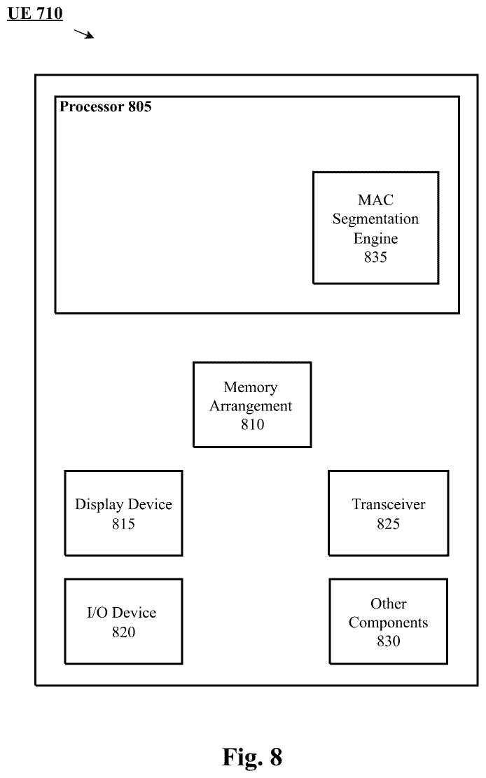

FIG. 8 shows an example UE 710 according to various example embodiments. The UE 710 will be described with regard to the network arrangement 700 of FIG. 7. The UE 710 may represent any electronic device and may include a processor 805, a memory arrangement 810, a display device 815, an input/output (I/O) device 820, a transceiver 825, and other components 830. The other components 830 may include, for example, an audio input device, an audio output device, a battery that provides a limited power supply, a data acquisition device, ports to electrically connect the UE 710 to other electronic devices, sensors to detect conditions of the UE 710, etc.

The processor 805 may be configured to execute a plurality of engines for the UE 710. For example, the engines may include a MAC segmentation engine 835 for performing operations related to MAC segmentation, as described in detail above.

The above referenced engine being an application (e.g., a program) executed by the processor 805 is only an example. The functionality associated with the engines may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 805 is split among two or more processors such as a baseband processor and an applications processor. The example embodiments may be implemented in any of these or other configurations of a UE.

The memory arrangement 810 may be a hardware component configured to store data related to operations performed by the UE 710. The display device 815 may be a hardware component configured to show data to a user while the I/O device 820 may be a hardware component that enables the user to enter inputs. The display device 815 and the I/O device 820 may be separate components or integrated together such as a touchscreen.

The transceiver 825 may be a hardware component configured to establish a connection with the 5G NR-RAN 720, an LTE-RAN (not pictured), a legacy RAN (not pictured), a WLAN (not pictured), etc. Accordingly, the transceiver 825 may operate on a variety of different frequencies or channels (e.g., set of consecutive frequencies). The transceiver 825 includes circuitry configured to transmit and/or receive signals (e.g., control signals, data signals). Such signals may be encoded with information implementing any one of the methods described herein. The processor 805 may be operably coupled to the transceiver 825 and configured to receive from and/or transmit signals to the transceiver 825. The processor 805 may be configured to encode and/or decode signals (e.g., signaling from a base station of a network) for implementing any one of the methods described herein.

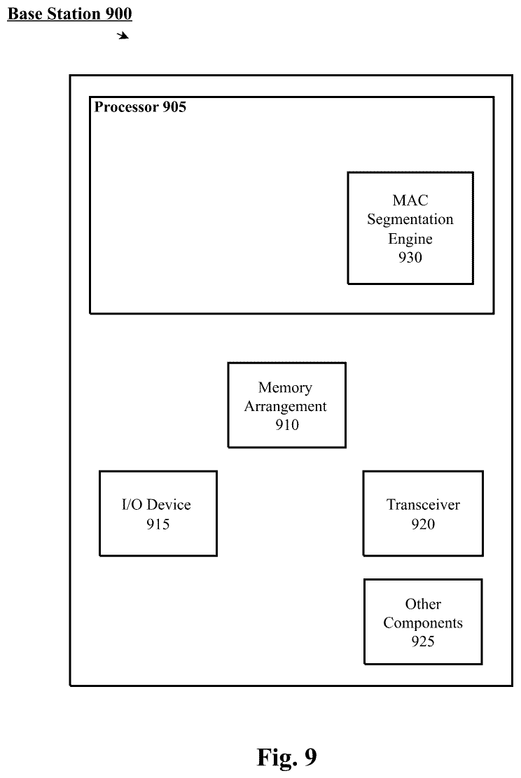

FIG. 9 shows an example base station 900 according to various example embodiments. The base station 900 may represent the gNB 720A, the gNB 720B or any other access node through which the UE 710 may establish a connection and manage network operations. The base station 900 may operate as the MN or the SN as described in the examples above.

The base station 900 may include a processor 905, a memory arrangement 910, an input/output (I/O) device 915, a transceiver 920, and other components 925. The other components 925 may include, for example, an audio input device, an audio output device, a battery, a data acquisition device, ports to electrically connect the base station 900 to other electronic devices and/or power sources, etc.

The processor 905 may be configured to execute a plurality of engines for the UE 710. For example, the engines may include a MAC segmentation engine 930 for performing operations related to MAC segmentation, as described in detail above.

The memory arrangement 910 may be a hardware component configured to store data related to operations performed by the base station 900. The I/O device 915 may be a hardware component or ports that enable a user to interact with the base station 900.

The transceiver 920 may be a hardware component configured to exchange data with the UE 710 and any other UE in the network arrangement 700. The transceiver 920 may operate on a variety of different frequencies or channels (e.g., set of consecutive frequencies). The transceiver 920 includes circuitry configured to transmit and/or receive signals (e.g., control signals, data signals). Such signals may be encoded with information implementing any one of the methods described herein. The processor 905 may be operably coupled to the transceiver 920 and configured to receive from and/or transmit signals to the transceiver 920. The processor 905 may be configured to encode and/or decode signals (e.g., signaling from a UE) for implementing any one of the methods described herein.

### Examples

In a first example, a method, comprising attempting to decode a first transport block (TB) scheduled for downlink (DL) reception by a first downlink control information (DCI), the first TB associated with a first hybrid automatic repeat request (HARQ) process and containing a first medium access control (MAC) protocol data unit (PDU), when the attempt to decode the first TB and receive the first MAC PDU is unsuccessful, generating, for transmission to a network, a first non-acknowledgment (NACK), detecting, in a second DCI, an indication that the first MAC PDU is to be segmented into at least two MAC segments to be transmitted, attempting to decode at least two further TBs, each further TB containing a respective one of the at least two MAC segments and concatenating each successfully decoded MAC segment to receive the first MAC PDU.

In a second example, the method of the first example, wherein the at least two MAC segments are transmitted sequentially.

In a third example, the method of the second example, further comprising attempting to decode a second TB scheduled for DL reception by the second DCI, the second TB associated with the first HARQ process and containing a first MAC segment.

In a fourth example, the method of the third example, further comprising, when decoding the second TB and receiving the first MAC segment is successful, storing the first MAC segment and generating, for transmission to the network, a first acknowledgment (ACK).

In a fifth example, the method of the fourth example, further comprising detecting, in a third DCI, an indication that a third TB scheduled for DL reception by the third DCI is associated with the first HARQ process and is to contain a second MAC segment that is a non-last MAC segment, attempting to decode the third TB, when the attempt to decode the third TB and receive the second MAC segment is successful, storing the second MAC segment and generating, for transmission to the network, a second ACK.

In a sixth example, the method of the fifth example, further comprising detecting, in a fourth DCI, an indication that a fourth TB scheduled for DL reception by the fourth DCI is associated with the first HARQ process and is to contain a third MAC segment that is a last MAC segment, attempting to decode the fourth TB, when the attempt to decode the fourth TB and receive the third MAC segment is successful, concatenating the first, second and third MAC segments into a first reassembled MAC PDU and generating, for transmission to the network, a second ACK.

In a seventh example, the method of the sixth example, wherein a receiving MAC entity concatenates the first, second and third MAC segments into the first reassembled MAC PDU, processes the first reassembled MAC PDU to generate one or more radio link control (RLC) PDUs, and passes the one or more RLC PDUs to a receiving RLC entity.

In an eighth example, the method of the seventh example, wherein the second, third and fourth DCI each comprises a MAC segmentation indication (MSI) field, the MSI field comprising a single bit flag, wherein the indication in the second DCI for the first MAC segment comprises toggling the MSI field to a first value, wherein the indication in the third DCI for the second MAC segment being a non-last MAC segment comprises maintaining the MSI field set to the first value and wherein the indication in the fourth DCI for the third MAC segment being the last MAC segment comprises toggling the MSI field to a second value.

In a ninth example, the method of the eighth example, wherein the second, third and fourth DCI each comprises a new data indicator (NDI) field, the NDI field comprising a single bit flag, wherein the indication in the second DCI for the first MAC segment further comprises toggling the NDI field, wherein the indication in the third DCI for the second MAC segment being a non-last MAC segment further comprises toggling the NDI field, wherein the indication in the fourth DCI for the third MAC segment being the last MAC segment further comprises not toggling the NDI field.

In a tenth example, the method of the third example, further comprising, when decoding the second TB and receiving the first MAC segment is unsuccessful, buffering soft bits of the second TB and generating, for transmission to the network, a second NACK.

In an eleventh sixth example, the method of the tenth example, further comprising detecting, in a third DCI, an indication that a third TB scheduled for DL reception by the third DCI is associated with the first HARQ process and is to contain a first retransmission of the first MAC segment and attempting to decode the third TB by soft combining soft bits of the third TB with the soft bits of the second TB.

In a twelfth example, the method of the eleventh example, further comprising, when the attempt to decode the third TB and receive the first MAC segment is successful, storing the first MAC segment and sequentially attempting to decode further MAC segments.

In a thirteenth example, the method of the eleventh example, further comprising, when the attempt to decode the third TB and receive the first MAC segment is unsuccessful, buffering the soft bits of the third TB and sequentially attempting to decode further retransmissions of the first MAC segment prior to attempting to decode transmissions of further MAC segments.

In a fourteenth example, the method of the eleventh example, wherein the second and third DCI each comprises a MAC segmentation indication (MSI) field, the MSI field comprising a single bit flag, wherein the indication in the second DCI for the first MAC segment comprises toggling the MSI field to a first value, wherein the indication in the third DCI for the first retransmission of the first MAC segment comprises maintaining the MSI field set to the first value, wherein the second and third DCI each comprises a new data indicator (NDI) field, the NDI field comprising a single bit flag, wherein the indication in the second DCI for the first MAC segment further comprises toggling the NDI field, and wherein the indication in the third DCI for the first retransmission of the first MAC segment further comprises not toggling the NDI

### FIELD

In a fifteenth example, the method of the second example, further comprising applying a dynamic radio link control (RLC) reassembly timer when the second DCI that indicates MAC segmentation is detected, the dynamic RLC reassembly timer comprising an extension to an initial RLC reassembly timer.

In a sixteenth example, the method of the second example, further comprising applying a dynamic packet data convergence protocol (PDCP) reordering timer when the second DCI that indicates MAC segmentation is detected, the dynamic PDCP reordering timer comprising an extension to an initial PRCP reordering timer.

In a seventeenth example, the method of the first example, wherein each of the at least two MAC segments comprise fewer bits than the first MAC PDU and are transmitted with a lower modulation and coding scheme (MCS).

In an eighteenth example, the method of the first example, wherein MAC segmentation is not applied prior to an initial transmission of an original MAC PDU.

In a nineteenth example, the method of the eighteenth example, wherein MAC segmentation is not applied prior to a predetermined number of HARQ retransmissions of an original MAC PDU.

In a twentieth example, the method of the nineteenth example, further comprising resetting HARQ buffers of the first HARQ process when the second DCI that indicates MAC segmentation is detected.

In a twenty first example, the method of the first example, wherein a number of MAC segments of a given segmented MAC PDU is not predetermined and is dependent on a modulation and coding scheme (MCS) and TB size of DL transmissions carrying the MAC segments.

In a twenty second example, the method of the second example, further comprising processing a first MAC segment received at a receiving MAC entity prior to receiving a second MAC segment at the receiving MAC entity.

In a twenty third example, the method of the twenty second example, further comprising applying MAC control elements (MAC-CE) contained in the first MAC segment prior to receiving the second MAC segment at the receiving MAC entity.

In a twenty fourth example, the method of the first example, wherein HARQ retransmissions of each MAC segment are retransmitted with different redundancy versions (RV) to enable per MAC segment combining.

In a twenty fifth example, the method of the first example, further comprising, when decoding the first TB and receiving the first MAC PDU is unsuccessful, buffering soft bits of the first TB and, when attempting to decode the further TBs containing the at least two MAC segments, soft combining the soft bits of the first TB with soft bits of the further TBs.

In a twenty sixth example, the method of the first example, wherein the at least two MAC segments are transmitted one of sequentially or in parallel.

In a twenty seventh example, the method of the twenty sixth example, further comprising, when decoding the first TB is unsuccessful, buffer soft bits of the first TB in a HARQ buffer and, when at least one of the further TBs is successfully decoded, setting a value of the soft bits of the first TB corresponding to the soft bits of the at least one of the further TBs to an indication corresponding to a known value of each of the bits.

In a twenty eighth example, the method of the twenty seventh example, further comprising attempting to decode the first TB based on the soft bits stored in the HARQ buffer.

In a twenty ninth example, the method of the twenty seventh example, further comprising generating, for transmission to the network, HARQ feedback comprising an indication of one of the first TB has been correctly decoded, at least one of the further TBs has been correctly decoded or none of the further TBs have been correctly decoded.

In a thirtieth example, the method of the twenty ninth example, wherein the HARQ feedback further comprises an indication of one or more of the further TBs to aid decoding of the first TB.

In a thirty first example, the method of the twenty sixth example, wherein, when the at least two MAC segments are transmitted in parallel, a DCI requesting each MAC segment comprises a MAC segment identification (ID).

In a thirty second example, the method of the thirty first example, wherein each MAC segment comprises a same HARQ process as the first TB or a different HARQ process from the first TB.

In a thirty third example, the method of the thirty second example, wherein, when the MAC segments comprise the different HARQ process from the first TB, the processing circuitry is further configured to determine a mapping between the HARQ process of the first TB and the different HARQ processes.

In a thirty fourth example, the method of the thirty third example, wherein the mapping is determined by determining a size of all MAC segments based on the DCI for all the MAC segment IDs and a size of the first TB.

In a thirty fifth example, the method of the thirty third example, wherein the mapping is determined based on a bit offset of the DCI with respect to the first TB.

In a thirty sixth example, the method of the thirty fifth example, wherein the MAC segment ID and a bit offset with respect to the first TB is indicated in a MAC header of each MAC segment.

In a thirty seventh example, the method of the first example, further comprising determining a size of the at least two further TBs based on information included in the second DCI.

In a thirty eighth example, the method of the first example, wherein the first TB comprises a plurality of code block groups (CBGs), wherein at least one of the plurality of CBGs is successfully decoded, wherein the NACK comprises a NACK for each of the CBGs that were not successfully decoded.

In a thirty ninth example, the method of the thirty eighth example, wherein the at least two segments do not include data from the at least one of the plurality of CBGs that was successfully decoded.

In a fortieth example, a processor configured to perform any of the methods of the first through thirty ninth examples.

In a forty first example, a user equipment or base station configured to perform any of the methods of the first through thirty ninth examples.

In a forty second example, a method, comprising generating, for transmission to a network, a first transport block (TB) scheduled for uplink (UL) transmission by a first downlink control information (DCI), the first TB associated with a first hybrid automatic repeat request (HARQ) process and containing a first medium access control (MAC) protocol data unit (PDU), detecting, in a second DCI, an indication that the first MAC PDU is to be segmented into at least two MAC segments to be transmitted, segmenting the first MAC PDU into at least two MAC segments and generating, for transmission to the network, at least two further TBs, each further TB containing a respective one of the at least two MAC segments.

In a forty third example, the method of the forty second example, wherein the at least two MAC segments are transmitted sequentially.

In a forty fourth example, the method of the forty third example, further comprising generating a second TB scheduled for UL transmission by the second DCI, the second TB associated with the first HARQ process and containing a first MAC segment.

In a forty fifth example, the method of the forty fourth example, further comprising detecting, in a third DCI, an indication that a third TB scheduled for UL transmission by the third DCI is associated with the first HARQ process and is to contain a second MAC segment that is a non-last MAC segment and generating, for transmission to the network, the third TB containing the second MAC segment.

In a forty sixth example, the method of the forty fifth example, further comprising detecting, in a fourth DCI, an indication that a fourth TB scheduled for UL transmission by the fourth DCI is associated with the first HARQ process and is to contain a third MAC segment that is a last MAC segment and generating, for transmission to the network, the fourth TB containing the third MAC segment.

In a forty seventh example, the method of the forty sixth example, wherein the second, third and fourth DCI each comprises a MAC segmentation indication (MSI) field, the MSI field comprising a single bit flag, wherein the indication in the second DCI for the first MAC segment comprises toggling the MSI field to a first value, wherein the indication in the third DCI for the second MAC segment being a non-last MAC segment comprises maintaining the MSI field set to the first value and wherein the indication in the fourth DCI for the third MAC segment being the last MAC segment comprises toggling the MSI field to a second value.

In a forty eighth example, the method of the forty seventh example, wherein the second, third and fourth DCI each comprises a new data indicator (NDI) field, the NDI field comprising a single bit flag, wherein the indication in the second DCI for the first MAC segment further comprises toggling the NDI field, wherein the indication in the third DCI for the second MAC segment being a non-last MAC segment further comprises toggling the NDI field and wherein the indication in the fourth DCI for the third MAC segment being the last MAC segment further comprises not toggling the NDI field.

In a forty ninth example, the method of the forty fourth example, further comprising detecting, in a third DCI, an indication that a third TB scheduled for UL transmission by the third DCI is associated with the first HARQ process and is to contain a first retransmission of the first MAC segment and generating, for transmission to the network, the third TB containing the first retransmission of the first MAC segment.

In a fiftieth example, the method of the forty ninth example, wherein the second and third DCI each comprises a MAC segmentation indication (MSI) field, the MSI field comprising a single bit flag, wherein the indication in the second DCI for the first MAC segment comprises toggling the MSI field to a first value, wherein the indication in the third DCI for the first retransmission of the first MAC segment comprises maintaining the MSI field set to the first value, wherein the second and third DCI each comprises a new data indicator (NDI) field, the NDI field comprising a single bit flag, wherein the indication in the second DCI for the first MAC segment further comprises toggling the NDI field, and wherein the indication in the third DCI for the first retransmission of the first MAC segment further comprises not toggling the NDI

### FIELD

In a fifty first example, the method of the forty second example, wherein each of the at least two MAC segments comprise fewer bits than the first MAC PDU and are transmitted with a lower modulation and coding scheme (MCS).

In a fifty second example, the method of the forty second example, further comprising determining to request MAC segmentation based on internal logic and generating, for transmission to the network, a request for MAC segmentation.

In a fifty third example, the method of the fifty second example, wherein the request is transmitted in a MAC control element (MAC CE) included in another MAC PDU or uplink control information.

In a fifty fourth example, the method of the fifty third example, wherein the internal logic comprises that MAC segmentation is not applied prior to an initial transmission of an original MAC PDU.

In a fifty fifth example, the method of the fifty fourth example, wherein the internal logic comprises that MAC segmentation is not applied prior to a predetermined number of HARQ retransmissions of an original MAC PDU.

In a fifty sixth example, the method of the fifty fourth example, further comprising resetting HARQ buffers of the first HARQ process when the second DCI that indicates MAC segmentation is detected.

In a fifty seventh example, the method of the forty second example, wherein a number of MAC segments of a given segmented MAC PDU is not predetermined and is dependent on a modulation and coding scheme (MCS) and TB size of UL transmissions carrying the MAC segments.

In a fifty eighth example, the method of the forty second example, wherein HARQ retransmissions of each MAC segment are retransmitted with different redundancy versions (RV) to enable per MAC segment combining.

In a fifty ninth example, the method of the forty second example, wherein the at least two MAC segments are transmitted one of sequentially or in parallel.

In a sixtieth example, the method of the fifty ninth example, wherein, when the at least two MAC segments are transmitted in parallel, a DCI requesting each MAC segment comprises a MAC segment identification (ID).

In a sixty first example, the method of the sixtieth example, wherein each MAC segment comprises a same HARQ process as the first TB or a different HARQ process from the first TB.

In a sixty second example, the method of the sixty first example, wherein, when the MAC segments comprise the different HARQ process from the first TB, the processing circuitry is further configured to determine a mapping between the HARQ process of the first TB and the different HARQ processes.

In a sixty third example, the method of the sixty second example, wherein the mapping is determined by determining a size of all MAC segments based on the DCI for all the MAC segment IDs and a size of the first TB.

In a sixty fourth example, the method of the sixty second example, wherein the mapping is determined based on a bit offset of the DCI with respect to the first TB.

In a sixty fifth example, the method of the sixty first example, wherein the MAC segment ID and a bit offset with respect to the first TB is indicated in a MAC header of each MAC segment.

In a sixty sixth example, a processor configured to perform any of the methods of the forty second through sixty fifth examples.

In a sixty seventh example, a user equipment configured to perform any of the methods of the forty second through sixty fifth examples.

In a sixty eighth example, a method, comprising processing, based on signaling from a transmitter, a first transport block (TB) associated with a first hybrid automatic repeat request (HARQ) process and containing a first medium access control (MAC) protocol data unit (PDU), wherein at least a portion of the TB is unsuccessfully decoded and processing, based on signaling from the transmitter, a second TB comprising a MAC control element (MAC-CE) indicating a level of importance of data in the first TB.

In a sixty ninth example, the method of the sixty eighth example, wherein the first TB also includes the MAC-CE.

In a seventieth example, the method of the sixty eighth example, further comprising processing, based on signaling from the transmitter, a third TB comprising a MAC segment that comprises a portion of the first MAC PDU.

In a seventy first example, the method of the seventieth example, wherein the level of importance comprises a first level of importance, wherein the method further comprises attempting to decode the third TB.

In a seventy second example, the method of the seventy first example, wherein the third TB comprises a plurality of TBs, each of the plurality of TBs comprising a different portion of the first MAC PDU, wherein the processing circuitry attempts to decode each of the plurality of third TBs.

In a seventy third example, the method of the seventieth example, wherein the level of importance comprises a second level of importance, wherein the method further comprises aborting decoding the third TB based on the indication of the second level of importance.

In a seventy fourth example, the method of the seventieth example, wherein the level of importance comprises a mixed level of importance comprising a first level of importance and a second level of importance, wherein the method further comprises attempting to decode the third TB when the third TB comprises data having the first level of importance or aborting decoding the third TB when the third TB comprises data having the second level of importance.

In a seventy fifth example, the method of the seventy fourth example, wherein the MAC-CE comprises an indication of a length or an offset associated with data having the first level of importance.

In a seventy sixth example, a processor configured to perform any of the methods of the sixty eighth through seventy fifth examples.

In a seventy seventh example, a user equipment or base station configured to perform any of the methods of the sixty eighth through seventy fifth examples.

In a seventy eighth example, a method, comprising generating, for transmission, a first transport block (TB) associated with a first hybrid automatic repeat request (HARQ) process and containing a first medium access control (MAC) protocol data unit (PDU) comprising data, detecting, in a second DCI, an indication that the first MAC PDU is to be segmented into at least two MAC segments to be transmitted, segmenting the first MAC PDU into at least two MAC segments and generating, for transmission to a network, at least two further TBs, each further TB containing a respective one of the at least two MAC segments, wherein a first one of the at least two further TBs comprises a MAC control element (MAC-CE) indicating a level of importance of data in the first TB.

In a seventy ninth example, the method of the seventy eighth example, wherein the first TB also includes the MAC-CE.

In an eightieth example, the method of the seventy eighth example, wherein the data in the first TB comprises first data having a first level of importance and second data having a second level of importance, wherein the at least two further TBs only comprise the first data.

In an eighty first example, the method of the eightieth example, wherein the MAC-CE further indicates a length of the first data in the first TB or an offset of the first data relative to the MAC-CE.

In an eighty second example, a processor configured to perform any of the methods of the seventy eighth through eighty first examples.

In an eighty third example, a user equipment or base station configured to perform any of the methods of the seventy eighth through eighty first examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry coupled to memory, wherein the processing circuitry is configured to:
attempt to decode a first transport block (TB) scheduled for downlink (DL) reception by a first downlink control information (DCI), the first TB associated with a first hybrid automatic repeat request (HARQ) process and containing a first medium access control (MAC) protocol data unit (PDU);
when the attempt to decode the first TB and receive the first MAC PDU is unsuccessful, generate, for transmission to a network, a first non-acknowledgment (NACK);
detect, in a second DCI, an indication that the first MAC PDU is to be segmented into at least two MAC segments to be transmitted;
attempt to decode at least two further TBs, each further TB containing a respective one of the at least two MAC segments; and
concatenate each successfully decoded MAC segment to receive the first MAC PDU.

2. The apparatus of claim 1, wherein the at least two MAC segments are transmitted sequentially.

3. The apparatus of claim 2, wherein the processing circuitry is further configured to:
attempt to decode a second TB scheduled for DL reception by the second DCI, the second TB associated with the first HARQ process and containing a first MAC segment.

4. The apparatus of claim 3, wherein the processing circuitry is further configured to:
when decoding the second TB and receiving the first MAC segment is successful, store the first MAC segment; and
generate, for transmission to the network, a first acknowledgment (ACK).

5. The apparatus of claim 4, wherein the processing circuitry is further configured to:
detect, in a third DCI, an indication that a third TB scheduled for DL reception by the third DCI is associated with the first HARQ process and is to contain a second MAC segment that is a non-last MAC segment;
attempt to decode the third TB;
when the attempt to decode the third TB and receive the second MAC segment is successful, store the second MAC segment; and
generate, for transmission to the network, a second ACK.

6. The apparatus of claim 5, wherein the processing circuitry is further configured to:
detect, in a fourth DCI, an indication that a fourth TB scheduled for DL reception by the fourth DCI is associated with the first HARQ process and is to contain a third MAC segment that is a last MAC segment;
attempt to decode the fourth TB;
when the attempt to decode the fourth TB and receive the third MAC segment is successful, concatenate the first, second and third MAC segments into a first reassembled MAC PDU; and
generate, for transmission to the network, a second ACK.

7. The apparatus of claim 6, wherein a receiving MAC entity concatenates the first, second and third MAC segments into the first reassembled MAC PDU, processes the first reassembled MAC PDU to generate one or more radio link control (RLC) PDUs, and passes the one or more RLC PDUs to a receiving RLC entity.

8. The apparatus of claim 7, wherein the second, third and fourth DCI each comprises a MAC segmentation indication (MSI) field, the MSI field comprising a single bit flag,
wherein the indication in the second DCI for the first MAC segment comprises toggling the MSI field to a first value,
wherein the indication in the third DCI for the second MAC segment being a non-last MAC segment comprises maintaining the MSI field set to the first value; and
wherein the indication in the fourth DCI for the third MAC segment being the last MAC segment comprises toggling the MSI field to a second value.

9. The apparatus of claim 8, wherein the second, third and fourth DCI each comprises a new data indicator (NDI) field, the NDI field comprising a single bit flag,
wherein the indication in the second DCI for the first MAC segment further comprises toggling the NDI field,
wherein the indication in the third DCI for the second MAC segment being a non-last MAC segment further comprises toggling the NDI field,
wherein the indication in the fourth DCI for the third MAC segment being the last MAC segment further comprises not toggling the NDI field.

10. The apparatus of claim 3, wherein the processing circuitry is further configured to:
when decoding the second TB and receiving the first MAC segment is unsuccessful, buffer soft bits of the second TB; and
generate, for transmission to the network, a second NACK.

11. The apparatus of claim 10, wherein the processing circuitry is further configured to:
detect, in a third DCI, an indication that a third TB scheduled for DL reception by the third DCI is associated with the first HARQ process and is to contain a first retransmission of the first MAC segment; and
attempt to decode the third TB by soft combining soft bits of the third TB with the soft bits of the second TB.

12. The apparatus of claim 11, wherein the processing circuitry is further configured to:
when the attempt to decode the third TB and receive the first MAC segment is successful, store the first MAC segment; and
sequentially attempt to decode further MAC segments.

13. The apparatus of claim 11, wherein the processing circuitry is further configured to:
when the attempt to decode the third TB and receive the first MAC segment is unsuccessful, buffer the soft bits of the third TB; and
sequentially attempt to decode further retransmissions of the first MAC segment prior to attempting to decode transmissions of further MAC segments.

14. The apparatus of claim 11, wherein the second and third DCI each comprises a MAC segmentation indication (MSI) field, the MSI field comprising a single bit flag,
wherein the indication in the second DCI for the first MAC segment comprises toggling the MSI field to a first value,
wherein the indication in the third DCI for the first retransmission of the first MAC segment comprises maintaining the MSI field set to the first value;
wherein the second and third DCI each comprises a new data indicator (NDI) field, the NDI field comprising a single bit flag,
wherein the indication in the second DCI for the first MAC segment further comprises toggling the NDI field, and
wherein the indication in the third DCI for the first retransmission of the first MAC segment further comprises not toggling the NDI field.

15. The apparatus of claim 2, wherein the processing circuitry is further configured to:
apply a dynamic radio link control (RLC) reassembly timer when the second DCI that indicates MAC segmentation is detected, the dynamic RLC reassembly timer comprising an extension to an initial RLC reassembly timer.

16. The apparatus of claim 2, wherein the processing circuitry is further configured to:
apply a dynamic packet data convergence protocol (PDCP) reordering timer when the second DCI that indicates MAC segmentation is detected, the dynamic PDCP reordering timer comprising an extension to an initial PRCP reordering timer.

17. The apparatus of claim 1, wherein each of the at least two MAC segments comprise fewer bits than the first MAC PDU and are transmitted with a lower modulation and coding scheme (MCS).

18. The apparatus of claim 1, wherein MAC segmentation is not applied prior to an initial transmission of an original MAC PDU.

19. The apparatus of claim 18, wherein MAC segmentation is not applied prior to a predetermined number of HARQ retransmissions of an original MAC PDU.

20. The apparatus of claim 19, wherein the processing circuitry is further configured to:
reset HARQ buffers of the first HARQ process when the second DCI that indicates MAC segmentation is detected.
